(19) United States
(12) Patent Application Publication
(10) Pub. No.: US 2024/0202686 A1
(43) Pub. Date: Jun. 20, 2024

(54) GENERATING GRAPHICAL USER INTERFACES COMPRISING DYNAMIC AVAILABLE DEPOSIT TRANSACTION VALUES DETERMINED FROM A DEPOSIT TRANSACTION PREDICTOR MODEL

(71) Applicant: Chime Financial, Inc., San Francisco, CA (US)

(72) Inventors: Elle Creel, San Francisco, CA (US); Ankit Jain, Mission Viejo, CA (US); Aoni Wang, Redwood City, CA (US); Carl Cummings, San Francisco, CA (US); Daniel Cash, Charlotte, NC (US); Di Mo, Mountain View, CA (US); James Sheak, San Mateo, CA (US); Meeri Shin, San Francisco, CA (US); Michael Homnick, San Francisco, CA (US); Michael Stumpo, Oakland, CA (US); Polina Munoz, San Francisco, CA (US); Victoria Palmiotto, Oakland, CA (US); Xuanxing Xiong, Santa Clara, CA (US); Yiyang Zeng, Everett, MA (US); Akhil Naini, New York, NY (US)

(21) Appl. No.: 18/153,814

(22) Filed: Jan. 12, 2023

Related U.S. Application Data
(60) Provisional application No. 63/387,625, filed on Dec. 15, 2022.

(51) Int. Cl. G06Q 20/10; G06Q 20/40

(52) U.S. Cl. CPC G06Q 20/108; G06Q 20/4015

(57) ABSTRACT

The disclosure describes embodiments of systems, methods, and non-transitory computer readable storage media that utilize deposit transaction prediction data from a deposit transaction predictor model to generate a graphical user interface (GUI) that indicates an available deposit balance and options for the available deposit balance. Indeed, the disclosed systems can enable access to an available deposit balance on a user account prior to an occurrence of a predicted deposit transaction as indicated by the deposit transaction predictor model. For example, the disclosed systems can receive deposit transaction prediction data from a data pipeline that includes a deposit transaction predictor model. Moreover, the disclosed systems can determine an available deposit balance from the deposit transaction prediction data. Then, the disclosed systems can enable, within a GUI, user selections of a pre-deposit transaction amount from the available deposit balance to modify a user account value based on the pre-deposit transaction amount.

### CROSS-REFERENCE TO RELATED APPLICATIONS

This application claims the benefit of, and priority to, U.S. Provisional Application No. 63/387,625, entitled “GENERATING GRAPHICAL USER INTERFACES COMPRISING DYNAMIC AVAILABLE DEPOSIT TRANSACTION VALUES DETERMINED FROM A DEPOSIT TRANSACTION PREDICTOR MODEL,” filed Dec. 15, 2022, the contents of which are hereby incorporated by reference in their entirety.

### BACKGROUND

Recent years have seen a significant development in systems that utilize web-based and mobile-based applications to manage user accounts and digital information for user accounts in real time. For example, many conventional applications provide various graphical user interfaces (GUIs) to present digital information and options to client devices. This often includes various conventional systems attempting to transform and utilize digital information of user accounts to enable functionalities for determining or calculating transactions and/or account-specific values from the digital information via the web-based and mobile-based applications. Although many conventional systems attempt to enable functions for determining or calculating transactions and/or account-specific values from the digital information, such conventional systems face a number of technical shortcomings, particularly with regard to inflexible, inefficient, and inaccurate user interfaces that enable limited functionalities from transformable data.

For example, conventional systems oftentimes cannot robustly (or flexibly) transform deposit transaction data of a user account to enable functionalities from the deposit transaction data. More specifically, many conventional systems cannot utilize deposit transaction data to provide insights into future deposit transactions of a user account to enable insightful applications catered towards one or more anticipated deposit transactions. Rather, many conventional systems utilize or enable access to only historical deposit transaction data for a user account.

Furthermore, conventional systems often inefficiently utilize user account data. For instance, many conventional systems may utilize user account data to predict or determine future behaviors of user accounts through user account data. However, these conventional systems lack data management and data modelling efficiency. Indeed, in many cases, conventional systems analyze data of a user account to determine future behaviors of the user account locally. Oftentimes, a local analysis of data leads to multiple computer networks and/or multiple devices inefficiently utilizing computing resources in an attempt to determine various future behaviors for a user account. To illustrate, oftentimes, such a local analysis approach requires computations at multiple systems and/or devices. Furthermore, utilizing a local analysis of data to determine various future behaviors for a user account often requires an increased amount of data transfers (i.e., an increase in bandwidth and storage of data at multiple locations) to systems and devices for analyzing and determining various future behaviors of the user account.

In addition, many conventional systems inefficiently utilize computational resources because of excessive navigation between user interfaces to present the above-mentioned information correctly within small screens of mobile devices. To illustrate, in order to determine and provide accurate information for the determined future behaviors within user accounts and functionalities for those future behaviors, conventional systems oftentimes interface with multiple third-party sources. In many cases, such conventional systems utilize a significant number of computational resources such as processing time, API protocol updates and synchronization, and network bandwidth to communicate with the multiple third-party sources to determine and update information related to the determined future behaviors and functionalities for the future behaviors within the GUIs in real time. As such, in many cases, conventional systems require navigation between multiple UIs (of multiple third-party sources) to display determined future user account behaviors and/or functionalities for those determinations within small screens of mobile devices.

Additionally, many conventional systems often utilize incomplete or partial data to determine inaccurate future behavioral data of user accounts. In particular, many conventional systems rely on locally available data that may overlook (or neglect) portions of unavailable user account activity that factors into future behavior predictions. Furthermore, in many instances, conventional systems also fail to continuously update future behavioral data in real time when updated user data is made available (e.g., due to computational resource limitations during a local analysis). Accordingly, such conventional systems are often unable to accurately determine predict user behaviors for user accounts from partial data to enable functionalities for the predicted user behaviors.

### SUMMARY

The disclosure describes one or more embodiments of systems, methods, and non-transitory computer-readable media that utilize deposit transaction prediction data from a deposit transaction predictor model to generate a graphical user interface (GUI) that indicates an available deposit balance and options for the available deposit balance. Indeed, the disclosed systems can enable access to an available deposit balance on a user account prior to an occurrence of a predicted deposit transaction as indicated by the deposit transaction predictor model. For example, the disclosed systems can receive deposit transaction prediction data from a data pipeline that transforms user account data with a deposit transaction predictor model. Moreover, the disclosed systems can determine an available deposit balance from the deposit transaction prediction data. In some embodiments, the disclosed systems utilize an available deposit balance model to determine an incremental amount to indicate as the available deposit balance based on user account activity and the deposit transaction prediction data. In some cases, the disclosed systems utilize a predicted deposit transaction amount (or an earned portion based on dates) to indicate the available deposit balance. Then, the disclosed systems can enable, within a graphical user interface, quick and efficient user selections of a pre-deposit transaction amount from the available deposit balance to modify a user account value based on the pre-deposit transaction amount.

### BRIEF DESCRIPTION OF THE DRAWINGS

The detailed description is described with reference to the accompanying drawings in which:

FIG. 1 illustrates a schematic diagram of an environment for implementing an inter-network facilitation system and a digital deposit transaction prediction system in accordance with one or more implementations.

FIG. 2 illustrates an overview of a digital deposit transaction prediction system utilizing deposit transaction prediction data to enable access to available deposit balances within GUIs in accordance with one or more implementations.

FIG. 3 illustrates an exemplary environment in which a digital deposit transaction prediction system utilizes a deposit transaction predictor model data pipeline in accordance with one or more implementations.

FIG. 4 illustrates a digital deposit transaction prediction system utilizing a deposit transaction predictor model from a deposit transaction prediction data pipeline in accordance with one or more implementations.

FIG. 5 illustrates a digital deposit transaction prediction system determining an available deposit balance for a user account from deposit transaction prediction data in accordance with one or more implementations.

FIGS. 6A-6F illustrate a digital deposit transaction prediction system utilizing determined available deposit balances to generate dynamic GUIs that enable access to the determined available deposit balances in accordance with one or more implementations.

FIGS. 7A-7C illustrate a digital deposit transaction prediction system utilizing an available deposit balance model to determine and update available deposit balances in accordance with one or more implementations.

FIG. 8 illustrates a digital deposit transaction prediction system displaying various information from a predicted deposit transaction in accordance with one or more implementations.

FIG. 9 illustrates a digital deposit transaction prediction system predicted deposit transaction earnings in accordance with one or more implementations.

FIG. 10 illustrates displaying predicted deposit transaction amounts that account for previously utilized available deposit balances in accordance with one or more implementations.

FIG. 11 illustrates a flowchart of a series of acts for utilizing deposit transaction prediction data from a deposit transaction predictor model to generate a graphical user interface that indicates an available deposit balance and options for the available deposit balance in accordance with one or more implementations.

FIG. 12 illustrates a block diagram of an exemplary computing device in accordance with one or more implementations.

FIG. 13 illustrates an example environment for an inter-network facilitation system in accordance with one or more implementations.

### DETAILED DESCRIPTION

The disclosure describes one or more embodiments of a digital deposit transaction prediction system that generates a graphical user interface (GUI) that indicates an available deposit balance and options for the available deposit balance utilizing deposit transaction prediction data from a deposit transaction predictor model data pipeline. In particular, the digital deposit transaction prediction system can receive deposit transaction prediction data from a data pipeline that transforms user account data with a deposit transaction predictor model and determine an available deposit balance from the deposit transaction prediction data. Moreover, the digital deposit transaction prediction system can provide, for display within a GUI, selectable options to select a pre-deposit transaction amount from the available deposit balance that, once selected, modifies a user account value based on the selected pre-deposit transaction amount. Indeed, the digital deposit transaction prediction system can enable access to an available deposit balance on a user account prior to an occurrence of a deposit transaction corresponding to a predicted deposit transaction.

In one or more embodiments, the digital deposit transaction prediction system communicates with a deposit transaction predictor model data pipeline to receive deposit transaction prediction data for a user account. For instance, the digital deposit transaction prediction system accesses a data pipeline that utilizes a deposit transaction predictor model to determine deposit transaction prediction data for user accounts and enables universal access for the deposit transaction prediction data. In particular, the deposit transaction predictor model data pipeline can identify user account data from various data sources and analyze the user account data utilizing a deposit transaction predictor model to determine deposit transaction predictions for a user account. Indeed, in one or more implementations, the deposit transaction predictor model data pipeline determines deposit transaction prediction data, such as time-based deposit prediction data and value-based deposit prediction data. For instance, the deposit transaction predictor model data pipeline can determine a predicted date for a predicted deposit transaction, a predicted frequency for predicted deposit transactions (as the time-based deposit prediction data), and/or a predicted deposit transaction monetary amount for a predicted deposit transaction (as the value-based deposit prediction data).

Moreover, the deposit transaction predictor model data pipeline can continuously update a deposit transaction prediction data source with the deposit transaction prediction data to facilitate universal access to the deposit transaction prediction data on a user-to-user account basis in real time (or near-real time). Indeed, the digital deposit transaction prediction system can communicate with the deposit transaction predictor model data pipeline to access the deposit transaction prediction data source and receive deposit transaction prediction data for a user account. In some cases, the digital deposit transaction prediction system communicates with the deposit transaction predictor model data pipeline (via a data query service, such as an application programming interface (API) request).

Furthermore, the digital deposit transaction prediction system can utilize prediction data to generate dynamic GUIs that enable access to predicted deposit transactions on user accounts. In some cases, the digital deposit transaction prediction system can utilize a predicted deposit transaction amount to indicate an available deposit balance and selectable options to access the available deposit balance prior to an occurrence of the predicted deposit transaction on the user account. Moreover, in some implementations, the digital deposit transaction prediction system utilizes the available deposit balance to indicate and provide access to an amount of a predicted deposit transaction that is already earned by a user account before a date of a predicted deposit transaction based on the access date.

In one or more implementations, the digital deposit transaction prediction system utilizes an available deposit balance model that determines an available deposit balance based on the predicted deposit transaction amounts and user activities (or attributes) from the user account. For instance, the digital deposit transaction prediction system can select an amount range (or a categorized amount) for the available deposit balance based on the predicted deposit transaction amounts and user activities (or attributes) from the user account. Indeed, the digital deposit transaction prediction system can provide incremental access to early deposit balances utilize an available deposit balance model that maps predicted amounts and user activities to user activity tiers and corresponding available deposit balance ranges (e.g., amount ranges or categorized amounts).

Additionally, the digital deposit transaction prediction system can utilize the determined available deposit balance to generate dynamic GUIs that display the available deposit balance and enable functionalities for the available deposit balance. For example, the digital deposit transaction prediction system can provide, within a GUI, one or more selectable options to select a pre-deposit transaction amount from a range of the available deposit balance. Moreover, the digital deposit transaction prediction system can utilize a user selection of a pre-deposit transaction amount to modify a user account balance (e.g., add the selected pre-deposit transaction amount to the user account balance). Furthermore, in one or more embodiments, the digital deposit transaction prediction system detects subsequent deposit transactions corresponding to the predicted deposit transaction (that determined the available deposit balance) and deducts the user selected (and received) pre-deposit transaction amount from the subsequent deposit transaction. Indeed, the digital deposit transaction prediction system utilizes determined available deposit balances from predicted deposit transactions in a user account to enable early access to monetary funds from anticipated deposit transactions in the user account.

The digital deposit transaction prediction system can provide numerous technical advantages, benefits, and practical applications to relative conventional systems. For example, in contrast to conventional systems that fail to flexibly transform deposit transaction data to enable functionalities from the deposit transaction data, the digital deposit transaction prediction system can communicate with a deposit transaction predictor model data pipeline to transform deposit transaction data into robust prediction data that enables the digital deposit transaction prediction system to generate dynamic GUIs with selectable options stemming from the deposit transaction prediction data. Indeed, by transforming the deposit transaction data via the deposit transaction predictor model data pipeline, the digital deposit transaction prediction system enables flexible functionalities from otherwise rigid and static historical deposit transaction data in a user account.

Additionally, unlike many conventional systems that inefficiently utilize user account data through a lack of data management and data modelling efficiency, the digital deposit transaction prediction system can efficiently utilize data resources via data queries to a deposit transaction predictor model data pipeline. In particular, instead of analyzing data of user accounts to determine future behaviors of the user accounts locally (and using partial data) like in many conventional systems, the digital deposit transaction prediction system accesses (e.g., via application programming interface (API) calls) to a deposit transaction predictor model data pipeline that utilizes user data from various sources and continuously updates a deposit transaction prediction data source with real (or near-real) time deposit transaction prediction data. Indeed, the digital deposit transaction prediction system can utilize deposit transaction prediction data with less local computation and reduced data transfers by via data requests to the deposit transaction predictor model data pipeline.

Furthermore, the digital deposit transaction prediction system can generate flexible user interfaces that coherently present information corresponding to predicted deposit transaction data in limited screen spaces of GUIs. Indeed, the digital deposit transaction prediction system can utilize deposit transaction prediction data in a reduced number of user interfaces by displaying information for the predicted deposit transaction data (that updates in real or near-real time) and selectable options to select a pre-deposit transaction amount in relation to the information for the predicted deposit transaction data within combined user interfaces. Moreover, unlike many conventional systems, the digital deposit transaction prediction system can display the information for the predicted deposit transaction data and the selectable options to select a pre-deposit transaction amount with less reliance on third-party sources (i.e., with less user navigation to one or more user interfaces of third-party sources). In addition, by displaying information for the predicted deposit transaction data (that updates in real or near-real time) and selectable options to select a pre-deposit transaction amount in relation to the information for the predicted deposit transaction data within combined user interfaces, the digital deposit transaction prediction system, unlike many conventional systems, also efficiently reduces the computing resources needed to navigate between an excessive number of user interfaces.

Moreover, in contrast to many conventional systems that utilize incomplete or partial data to determine inaccurate future behavioral data of user accounts, the digital deposit transaction prediction system can utilize deposit transaction predictions that are updated in real time (or in near-real time) with a wider scope of data. More specifically, the digital deposit transaction prediction system can utilize deposit transaction predictions from a deposit transaction predictor model data pipeline that utilizes updated user account data from various data sources with a deposit transaction predictor model to update deposit transaction predictions when new (or updated) data is identified in the data pipeline. In addition, the deposit transaction predictor model data pipeline can receive (or identify) data from multiple sources, that are usually disjointed, for a user account that may factor into a deposit transaction prediction within the deposit transaction predictor model (e.g., resulting in deposit transaction predictions with improved accuracy). By doing so, the digital deposit transaction prediction system can continuously (or frequently) receive and/or utilize updated deposit transaction prediction data to enable selectable options for up-to-date and accurate deposit transaction prediction data that is determined from a wider scope of data.

As indicated by the foregoing discussion, the present disclosure utilizes a variety of terms to describe features and advantages of the digital deposit transaction prediction system. As used herein, the term “data pipeline” refers to a collection of services, tools, processes, and/or data sources that facilitate the movement and/or transformation of data between data sources and/or computer network services. As an example, a data pipeline can include various combinations of elements to receive or access data from a data source, transform and/or analyze the data, and/or store the data to a data repository. In some instances, the digital deposit transaction prediction system (and/or a deposit transaction predictor model data pipeline) can utilize data pipelines, such as, but not limited to, real-time data pipelines, batch pipelines, extract, transform, load (ETL) pipelines, big data pipelines, and/or extract, load, transform (ELT) pipelines.

As further used herein, the term “data source” refers to a service or repository (e.g., via hardware and/or software) that manages data (e.g., storage of data, access to data, collection of data). In some cases, a data source refers to a data service or data repository (e.g., via hardware and/or software) that manages data storage via cloud-based services and/or other networks (e.g., offline data stores, online data stores). To illustrate, a data source can include, but is not limited to, cloud computing-based data storage and/or local storage. In some cases, a data source can correspond to various cloud-based data service companies that facilitate the tracking, collection, storage, movement, and/or access to data. Furthermore, a data source can include a client device corresponding to a user account, a computer network corresponding to a deposit transaction source, and/or a user account transaction activity data repository.

As further used herein, the term “data request” (or sometimes referred to as “data source request”) refers to an instruction for a data source. In some cases, a data request can include instructions (or queries) to read from (and/or access) a data source (e.g., select data, export data) and/or write data to a data source (e.g., update data, delete data, insert into data, create database, create table, upload data). In some cases, the digital deposit transaction prediction system can utilize data source requests as a set of instructions for a data pipeline represented in a programming paradigm (e.g., an application programming interface (API) or other declarative language).

Furthermore, as used herein, the term “deposit prediction data” (or sometimes referred to as “deposit transaction prediction”) refers to information indicating one or more future activities corresponding to deposit transactions on a user account. Indeed, in one or more embodiments deposit prediction data can include information that indicates future deposit transaction activities in a user account through predicted dates, predicted frequencies, predicted amounts, and/or an amount of a future deposit transaction that is already earned by a user account before a date of a predicted deposit transaction. For example, in one or more embodiments, deposit prediction data includes time-based deposit prediction data and/or value-based deposit prediction data.

To illustrate, deposit prediction data can include time-based deposit prediction data that indicates a date for a future deposit transaction. Indeed, in one or more embodiments, time-based deposit prediction data indicates a predicted date at which a predicted (or anticipated) deposit transaction is likely to occur for a user account (e.g., a predicted direct deposit date and/or a predicted pay day within a user account). Moreover, in some cases, time-based deposit transaction data also indicates a predicted frequency at which predicted deposit transactions are likely to occur for a user account (e.g., direct deposits are likely to occur monthly, biweekly, weekly, daily).

Furthermore, deposit prediction data can include value-based deposit prediction data that indicates an amount corresponding to a future deposit transaction. For example, value-based deposit prediction data can indicate a monetary amount that will be deposited in a predicted (or anticipated) deposit transaction. Indeed, in some cases, the value-based deposit prediction data indicates a predicted pay amount for a direct deposit transaction (e.g., for pay from an employer or other source of income for the user account).

As used herein, the term “deposit transaction predictor model” refers to a model that determines (and/or outputs) deposit prediction data for a user account from user account data. For instance, a deposit transaction predictor model can include a mapping of information between various ranges or segments of user account data to various deposit transaction patterns (e.g., future deposit transaction dates, future deposit transaction amounts, future deposit transaction frequencies). Indeed, in one or more embodiments, a deposit transaction predictor model includes a rule-based model that determines patterns for future deposit transactions utilizing user account data, such as, but not limited to, historical user account deposit transactions. In some instances, a deposit transaction predictor model includes a machine learning model that determines (or outputs) predicted deposit transaction patterns for a user account from input user account data (e.g., historical user account deposit transactions, geo-locations, user account transaction history).

As used herein, the term “machine learning model” refers to a computer model that can be trained (e.g., tuned or learned) based on inputs to approximate unknown functions and corresponding outputs. As an example, a machine learning model can include, but is not limited to, a neural network (e.g., a convolutional neural network, recurrent neural network, or deep learning model), a decision tree (e.g., a gradient boosted decision tree, a random forest decision tree, a decision tree with variable or output probabilities), and/or a support vector machine.

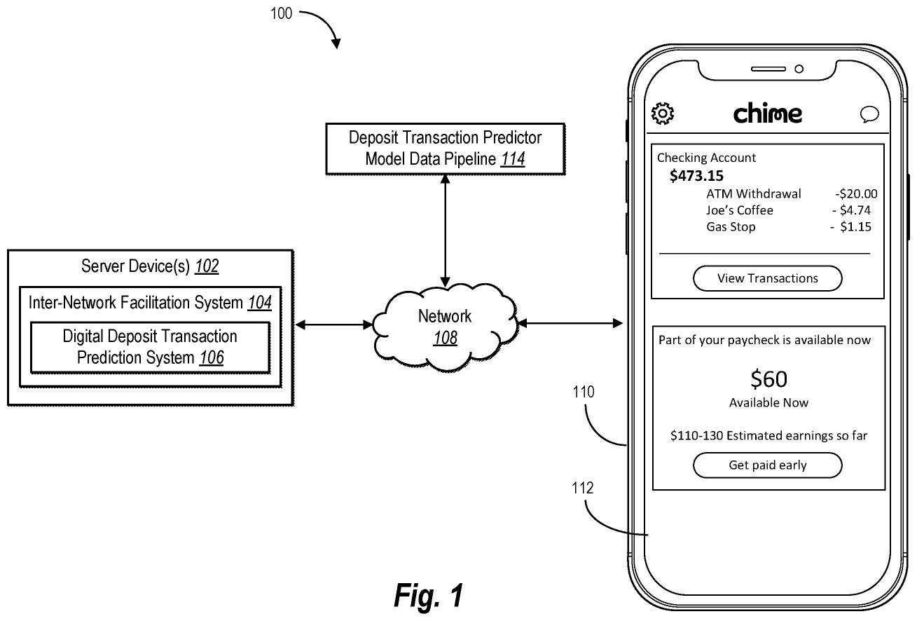

As used herein, the term “user account data” refers to information (or data) associated with interactions of a user within and/or in connection with an inter-network facilitation system (as described in FIG. 1). To illustrate, user account data can include, but is not limited to, historical utilization of an application, historical transaction activity within the user account (e.g., payments, setting changes, payment scheduling), historical deposit transactions, client device data (e.g., geo-location data, phone number data), historical withdrawal transactions, deposit transaction source information (e.g., employer, account information for deposit transaction party, pay stub data), and/or user data (e.g., address, email address, employment, estimated income).

Furthermore, as used herein, the term “available deposit balance” refers to a numerical value that represents a transactional value available for utilization in a user account (e.g., via a deposit transaction) in connection to a predicted, future deposit transaction. For example, in one or more embodiments, an available deposit balance can include a numerical value that represents an amount that a user account is permitted to obtain or transact due to a predicted, future deposit transaction. To illustrate, an available deposit balance can include a monetary advance amount (e.g., an early deposit transaction amount or an early pay amount) calculated using a predicted, future deposit transaction for the user account.

Moreover, as used herein, the term “pre-deposit transaction amount” refers to a numerical value selected from within a range of an available deposit balance to deposit within a user account. In particular, the pre-deposit transaction amount can include a numerical value (e.g., a monetary advance amount) that is deposited into a user account prior to an occurrence of a deposit transaction corresponding to a predicted, future deposit transaction for the user account. Additionally, in one or more embodiments, the pre-deposit transaction amount includes a user-selected numerical value that is less than or equal to an available deposit balance (determined in accordance with one or more implementations herein).

As used herein, the term “available deposit balance model” refers to a model that determines (and/or outputs) an available deposit balance (or available deposit balance range) for a user account from user activity data and deposit transaction prediction data. For instance, an available deposit balance model can include mappings of information between user activity data (or user account activity tiers), deposit transaction prediction data (e.g., amount ranges of deposit transaction prediction data, frequencies from the deposit transaction prediction data, date ranges from the deposit transaction prediction data), and output available deposit balances (or ranges for the available deposit balances). In some instances, the digital deposit transaction prediction system utilizes an available deposit balance model to determine a user account activity tier (e.g., a category level) for a user account based on user activity data corresponding to the user account and to determine an output available deposit balance.

In one or more embodiments, the available deposit balance model includes a machine learning model that outputs available deposit balances from learned mappings between user activity data (or user account activity tiers), deposit transaction prediction data, and available deposit balance. In some embodiments, the available deposit balance model includes a matrix model that includes mappings of user activity data (or user account activity tiers) and deposit transaction prediction data to one or more available deposit balances.

Turning now to the figures, FIG. 1 illustrates a block diagram of a system 100 (or system environment) for implementing an inter-network facilitation system 104 and a digital deposit transaction prediction system 106 in accordance with one or more embodiments. As shown in FIG. 1, the system 100 includes server device(s) 102 (which includes the inter-network facilitation system 104 and the digital deposit transaction prediction system 106), client device 110, and a deposit transaction predictor model data pipeline 114. As further illustrated in FIG. 1, the server device(s) 102, the client device 110, and the deposit transaction predictor model data pipeline 114 can communicate via the network 108.

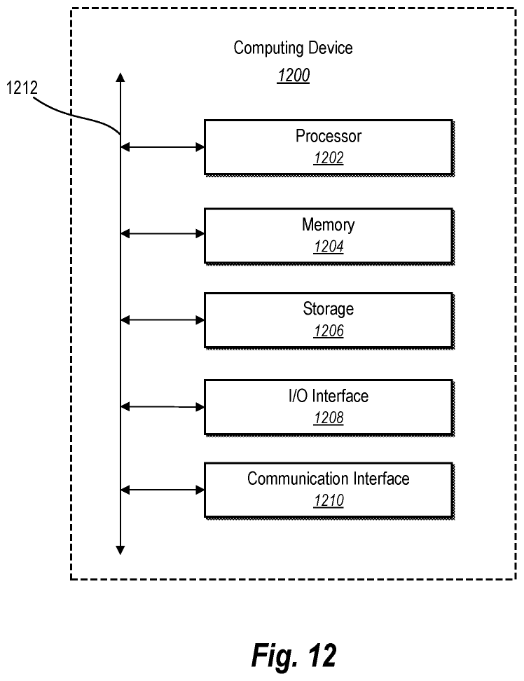

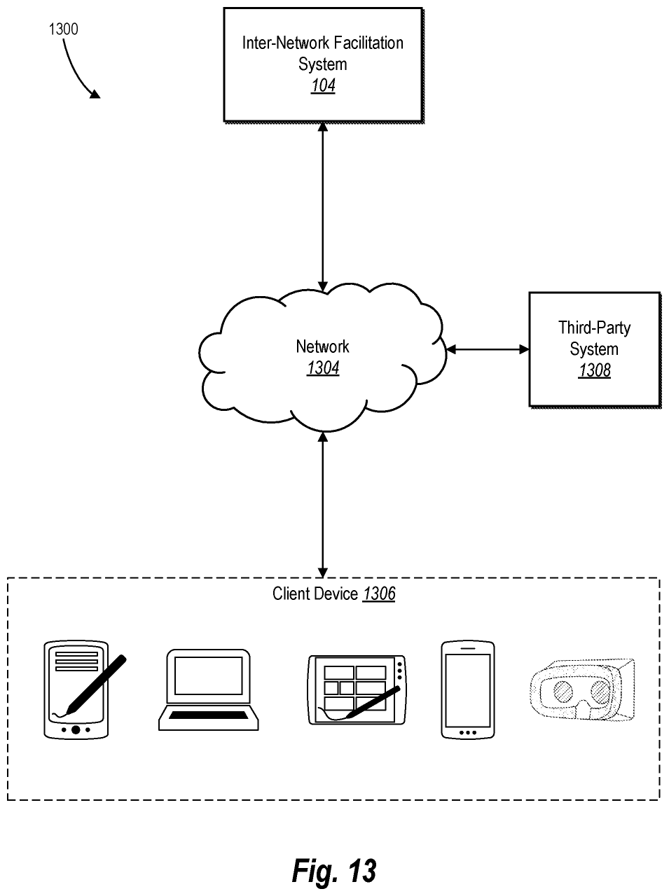

Although FIG. 1 illustrates the digital deposit transaction prediction system 106 being implemented by a particular component and/or device within the system 100, the digital deposit transaction prediction system can be implemented, in whole or in part, by other computing devices and/or components in the system 100 (e.g., the client device 110, the deposit transaction predictor model data pipeline 114). Additional description regarding the illustrated computing devices (e.g., the server device(s) 102, computing devices implementing the digital deposit transaction prediction system 106, the client device 110, the deposit transaction predictor model data pipeline 114, and/or the network 108) is provided with respect to FIGS. 12 and 13 below.

As shown in FIG. 1, the server device(s) 102 can include the inter-network facilitation system 104. In some embodiments, the inter-network facilitation system 104 can determine, store, generate, and/or display financial information corresponding to a user account (e.g., a banking application, a money transfer application). Furthermore, the inter-network facilitation system 104 can also electronically communicate (or facilitate) financial transactions between one or more user accounts (and/or computing devices). Moreover, the inter-network facilitation system 104 can also track and/or monitor financial transactions and/or financial transaction behaviors of a user within a user account.

The inter-network facilitation system 104 can include a system that comprises the digital deposit transaction prediction system 106 and that facilitates financial transactions and digital communications across different computing systems over one or more networks. For example, the inter-network facilitation system 104 manages credit accounts, secured accounts, and other accounts for one or more accounts registered within the inter-network facilitation system 104. In some cases, the inter-network facilitation system 104 is a centralized network system that facilitates access to online banking accounts, credit accounts, and other accounts within a central network location. Indeed, the inter-network facilitation system 104 can link accounts from different network-based financial institutions to provide information regarding, and management tools for, the different accounts.

In one or more embodiments, the digital deposit transaction prediction system 106 can utilize deposit transaction prediction data from a deposit transaction predictor model to generate GUIs that indicate an available deposit balance and options for the available deposit balance. In some cases, the digital deposit transaction prediction system 106 can receive deposit transaction prediction data from the deposit transaction predictor model data pipeline 114. In addition, the digital deposit transaction prediction system 106 can determine an available deposit balance from the deposit transaction prediction data and can enable access to an available deposit balance on a user account prior to an occurrence of a deposit transaction corresponding to a predicted deposit transaction (e.g., via GUIs on the client device 110) in accordance with one or more embodiments herein.

Furthermore, as shown in FIG. 1, the system 100 also includes the deposit transaction predictor model data pipeline 114. In one or more embodiments, the deposit transaction predictor model data pipeline 114 utilizes a deposit transaction predictor model to determine deposit transaction prediction data for user accounts and enable universal access for the deposit transaction prediction data to downstream computer network services. For instance, the deposit transaction predictor model data pipeline 114 can receive user account data from the data sources for one or more user accounts. Moreover, the deposit transaction predictor model data pipeline 114 can utilize the user account data with a deposit transaction predictor model to determine various deposit transaction prediction data and, subsequently, update the data sources with the deposit transaction prediction data to enable universal access for the deposit transaction prediction data to downstream computer network services (e.g., the digital deposit transaction prediction system 106). Moreover, although the system 100 illustrates the deposit transaction predictor model data pipeline 114 communicating with the inter-network facilitation system 104, in one or more embodiments, the deposit transaction predictor model data pipeline 114 is implemented within the server device(s) 102 (e.g., as part of the inter-network facilitation system 104).

In some cases, the deposit transaction predictor model data pipeline 114 can include a deposit transaction predictor model data pipeline as described in U.S. application Ser. No. 18/153,703, filed Jan. 12, 2023, entitled UTILIZING A DEPOSIT TRANSACTION PREDICTOR MODEL TO DETERMINE FUTURE NETWORK TRANSACTIONS (hereinafter “application Ser. No. 18/153,703”), the contents of which are herein incorporated by reference in their entirety.

Furthermore, as mentioned above, the deposit transaction predictor model data pipeline 114 utilizes one or more data sources to receive user account data and/or to store deposit transaction prediction data. Indeed, the data sources can manage and/or store various data for the inter-network facilitation system 104, the client device 110, and/or the deposit transaction predictor model data pipeline 114. As mentioned above, the data sources can include various data services or data repositories (e.g., via hardware and/or software) that manage data storage via cloud-based services and/or other networks (e.g., offline data stores, online data stores).

As also illustrated in FIG. 1, the system 100 includes the client device 110. For example, the client device 110 may include, but are not limited to, mobile devices (e.g., smartphones, tablets) or other type of computing devices, including those explained below with reference to FIGS. 12 and 13. Additionally, the client device 110 can include computing devices associated with (and/or operated by) user accounts for the inter-network facilitation system 104. Moreover, the system 100 can include various numbers of client devices that communicate and/or interact with the inter-network facilitation system 104 and/or the digital deposit transaction prediction system 106.

Furthermore, as shown in FIG. 1, the client device 110 can include a client application 112. The client application 112 can include instructions that (upon execution) cause the client device 110 to perform various actions. For example, a user of a user account can interact with the client application 112 on the client device 110 to access financial information, initiate a financial transaction (e.g., transfer money to another account, deposit money, withdraw money), and/or access or provide data (to the server device(s) 102). Furthermore, in one or more implementations, the client application 112 can display one or more GUIs, for the digital deposit transaction prediction system 106, to display selectable options to select a pre-deposit transaction amount from the available deposit balance that, once selected, modifies a user account value based on the selected pre-deposit transaction amount (in accordance with one or more embodiments herein).

In certain instances, the client device 110 corresponds to one or more user accounts (e.g., user accounts stored at the server device(s) 102). For instance, a user of a client device can establish a user account with login credentials and various information corresponding to the user. In addition, the user accounts can include a variety of information regarding financial information and/or financial transaction information for users (e.g., name, telephone number, address, bank account number, credit amount, debt amount, financial asset amount), payment information (e.g., account numbers), transaction history information, and/or contacts for financial transactions. In some embodiments, a user account can be accessed via multiple devices (e.g., multiple client devices) when authorized and authenticated to access the user account within the multiple devices.

The present disclosure utilizes client devices to refer to devices associated with such user accounts. In referring to a client (or user) device, the disclosure and the claims are not limited to communications with a specific device, but any device corresponding to a user account of a particular user. Accordingly, in using the term client device, this disclosure can refer to any computing device corresponding to a user account of the inter-network facilitation system 104.

As further shown in FIG. 1, the system 100 includes the network 108. As mentioned above, the network 108 can enable communication between components of the system 100. In one or more embodiments, the network 108 may include a suitable network and may communicate using a various number of communication platforms and technologies suitable for transmitting data and/or communication signals, examples of which are described with reference to FIG. 13. Furthermore, although FIG. 1 illustrates the server device(s) 102, the client device 110, and the deposit transaction predictor model data pipeline 114 communicating via the network 108, the various components of the system 100 can communicate and/or interact via other methods (e.g., the server device(s) 102 and the client device 110 can communicate directly).

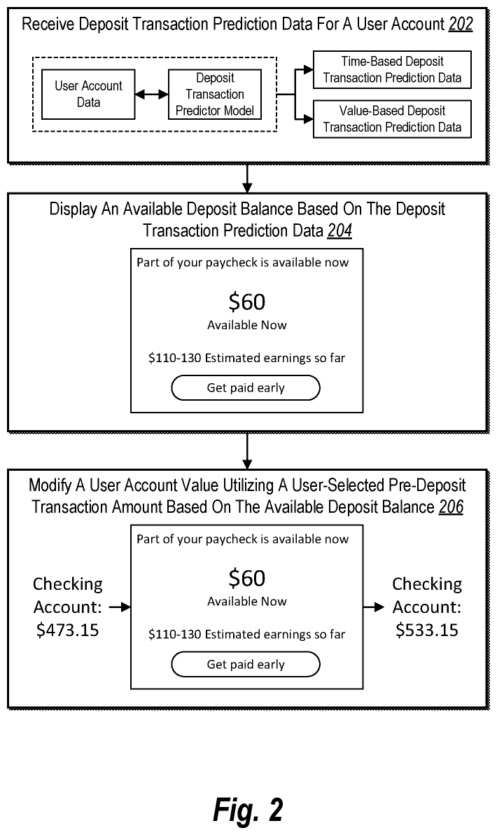

As mentioned above, the digital deposit transaction prediction system 106 can utilize deposit transaction prediction data from a deposit transaction predictor model to generate GUIs that indicate an available deposit balance and options for the available deposit balance. For example, FIG. 2 illustrates an overview of the digital deposit transaction prediction system 106 utilizing deposit transaction prediction data to enable access to available deposit balances within GUIs (and functionalities for the available deposit balances). In particular, as shown in FIG. 2, the digital deposit transaction prediction system 106 receives deposit transaction prediction data for a user account, displays an available deposit balance based on the deposit transaction prediction data, and modifies a user account value utilizing a user-selected pre-deposit transaction amount based on the available deposit balance.

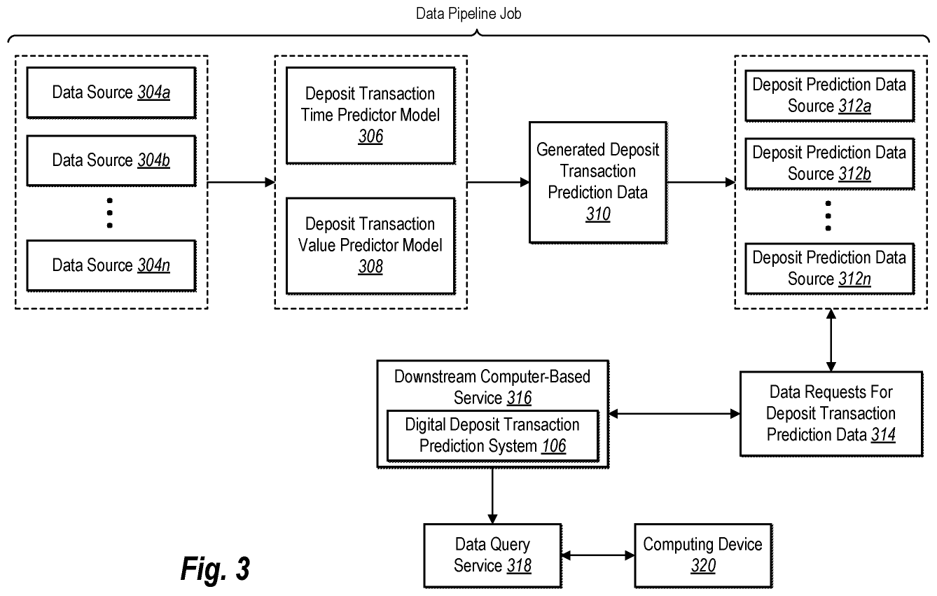

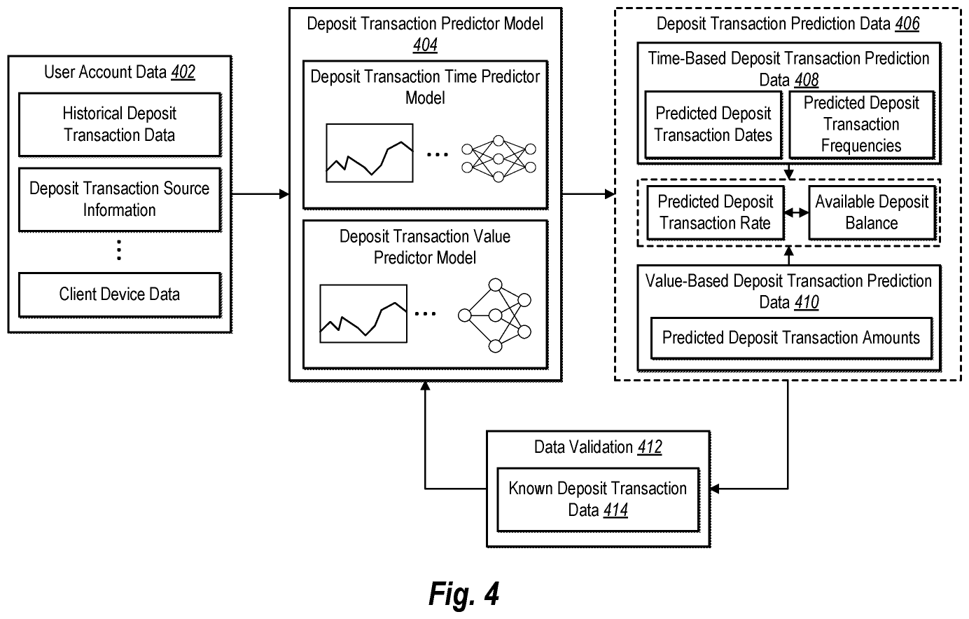

As shown in act 202 of FIG. 2, the digital deposit transaction prediction system 106 receives deposit transaction prediction data for a user account. For example, as shown in the act 202 of FIG. 2, the digital deposit transaction prediction system 106 can receive time-based deposit prediction data and value-based deposit prediction data (as deposit transaction prediction data) from a deposit transaction predictor model data pipeline that analyzes user account data. Indeed, the digital deposit transaction prediction system 106 can receive and/or utilize a deposit transaction predictor model data pipeline as described below (e.g., in relation to FIGS. 3 and 4).

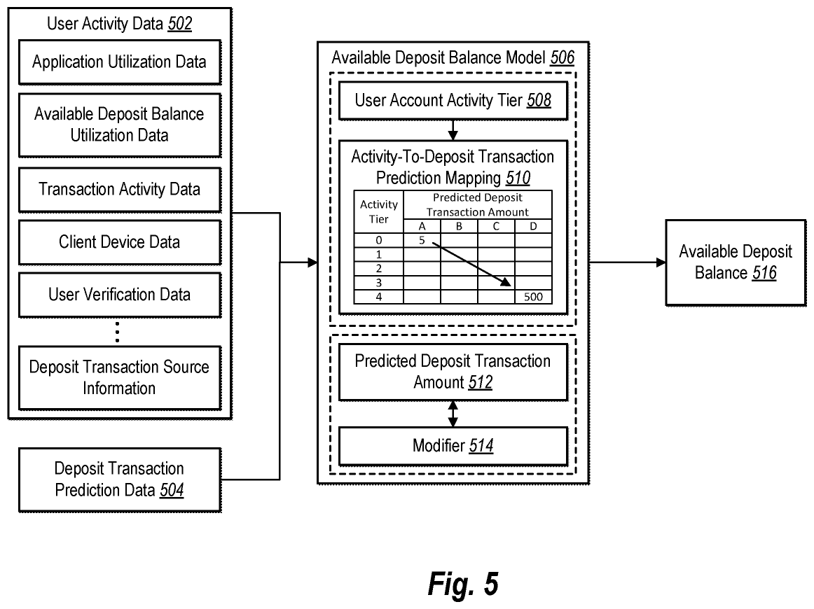

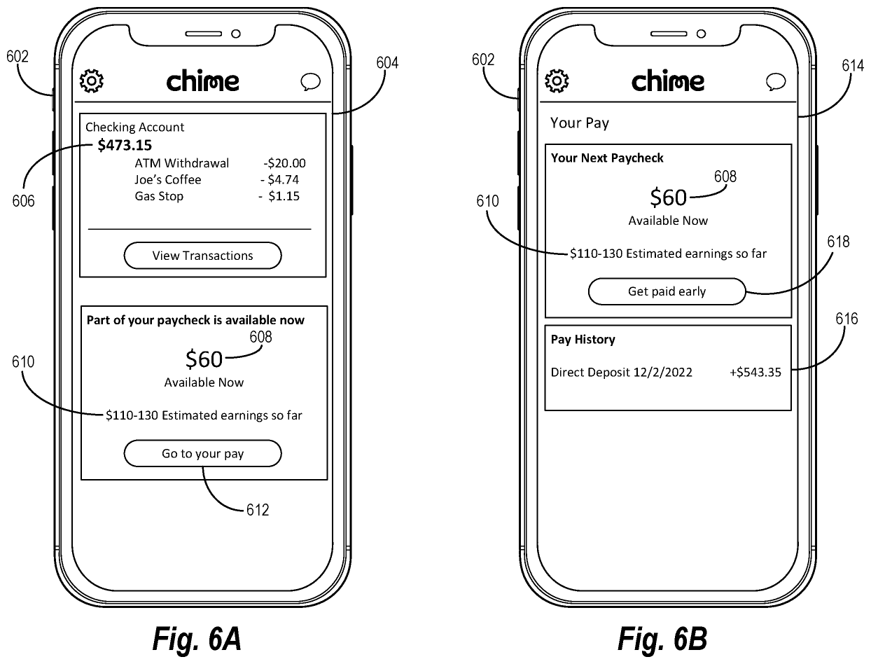

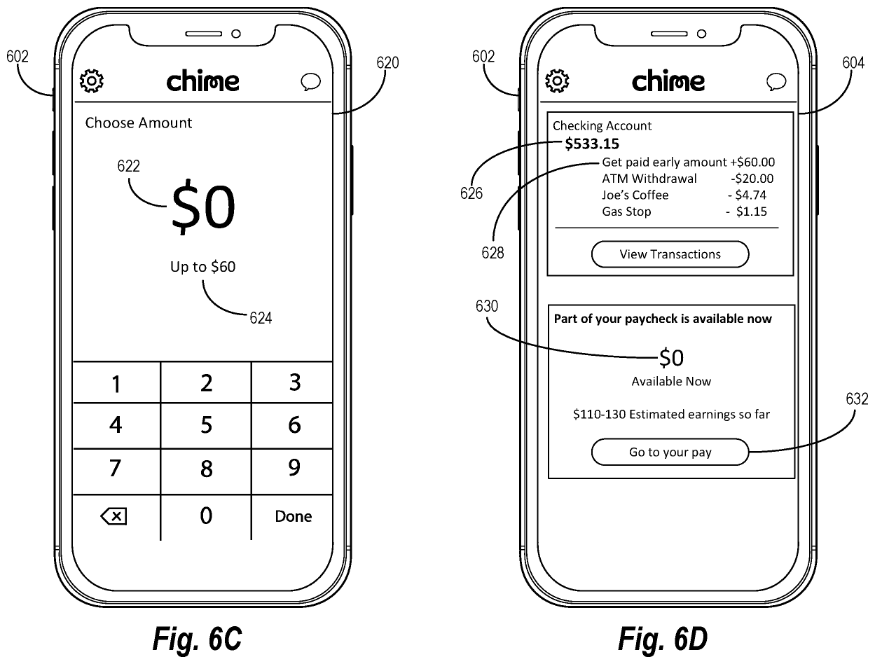

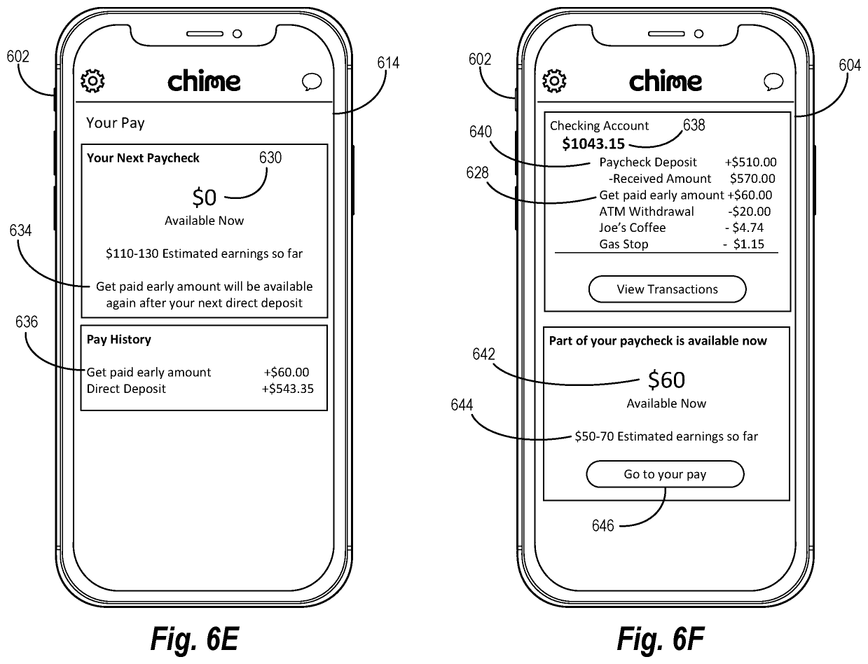

Furthermore, as shown in act 204 of FIG. 2, the digital deposit transaction prediction system 106 displays an available deposit balance based on the deposit transaction prediction data. In one or more embodiments, the digital deposit transaction prediction system 106 can utilize the deposit transaction prediction data to determine an available deposit balance. For instance, the digital deposit transaction prediction system 106 can determine the available deposit balance by directly utilizing the deposit transaction prediction data and/or an available deposit balance range by utilizing an available deposit balance model (based on user activity data and the deposit transaction prediction data). Moreover, as shown in FIG. 2, upon determining the available deposit balance data, the digital deposit transaction prediction system 106 can display the available deposit balance value with selectable options to access the available deposit balance value within a GUI of a client device corresponding to a user account. Indeed, the digital deposit transaction prediction system 106 can determine available deposit balances as described below (e.g., in relation to FIG. 5) and display available deposit balances and/or other data from the deposit transaction prediction data as also described below (e.g., in relation to FIGS. 6-12).

Moreover, as shown in act 206 of FIG. 2, the digital deposit transaction prediction system 106 modifies a user account value utilizing a user-selected pre-deposit transaction amount based on the available deposit balance. For instance, the digital deposit transaction prediction system 106 can display selectable options with the determined available deposit balance to enable a selection of a pre-deposit transaction amount within a range of the determined available deposit balance. Moreover, upon receiving a user selection of a pre-deposit transaction amount, the digital deposit transaction prediction system 106 can modify the user account value (e.g., checking account value) of the user to include the pre-deposit transaction amount (e.g., by adding funds) prior to the digital deposit transaction prediction system 106 detecting (or receiving) a subsequent, predicted deposit transaction. Indeed, the digital deposit transaction prediction system 106 can modify a user account value utilizing a user-selected pre-deposit transaction amount based on a determined available deposit balance as described below (e.g., in relation to FIGS. 6-12).

As mentioned above, the digital deposit transaction prediction system 106 can utilize a deposit transaction predictor model data pipeline to determine and/or access deposit transaction prediction data. To illustrate, FIG. 3 illustrates an exemplary environment in which the deposit transaction predictor model data pipeline operates. For example, as shown in FIG. 3, the deposit transaction predictor model data pipeline receives user account data from one or more of data sources 304a-304n and utilizes the user account data with deposit transaction prediction models to generate deposit transaction prediction data. Indeed, as shown in FIG. 3, the deposit transaction predictor model data pipeline utilizes data from the data sources 304a-304n with a deposit transaction date predictor model 306 and a deposit transaction value prediction model 308 to determine the generated deposit transaction prediction data 310.

Furthermore, as shown in FIG. 3, the deposit transaction predictor model data pipeline updates one or more of deposit prediction data sources 312a-312n with the generated deposit transaction prediction data 310. Indeed, as further shown in FIG. 3, the deposit transaction predictor model data pipeline facilitates access to deposit transaction prediction data at downstream services (e.g., the digital deposit transaction prediction system 106) utilizing the updated deposit prediction data sources 312a-312n. In particular, as shown in FIG. 3, the deposit transaction predictor model data pipeline enables a downstream computer-based service 316 (e.g., the digital deposit transaction prediction system 106) to utilize a data query service 318 to transmit data requests 314 for deposit transaction prediction data to the deposit prediction data sources 312a-312n. Upon receiving the data requests 314, the deposit transaction predictor model data pipeline causes the deposit prediction data sources 312a-312n to provide one or more elements for value-based and/or time-based deposit transaction data to the digital deposit transaction prediction system 106. In addition, in one or more embodiments, the digital deposit transaction prediction system 106 can utilize the received one or more elements for the value-based and/or time-based deposit transaction data to create and/or enable one or more functionalities (e.g., selectable options to utilize an available deposit balance) for a computing device 320 (e.g., a client device corresponding to a user account) as described below (e.g., in relation to FIGS. 5-12).

In one or more embodiments, the digital deposit transaction prediction system 106 utilizes the deposit transaction predictor data pipeline to access predicted deposit transaction data for multiple user accounts in real (or near-real) time. In particular, in reference to FIG. 3, the deposit transaction predictor model data pipeline iteratively (or continuously) receives (or requests) user account data (e.g., as part of a data pipeline job schedule individually or as a batch of user account data) from the one or more data sources 304a-304n (e.g., updated user account data). Moreover, the deposit transaction predictor model data pipeline utilizes the updated user account data with the deposit transaction date predictor model 306 and the deposit transaction value prediction model 308 to generate updated deposit transaction prediction data for the one or more user accounts. Subsequently, the deposit transaction predictor model data pipeline updates (e.g., via publishing or stream) the one or more deposit prediction data sources 312a-312n with the updated deposit transaction prediction data. Accordingly, in reference to FIG. 3, the digital deposit transaction prediction system 106 can request and receive updated deposit transaction prediction data (in real or near-real time) from the continuously updating one or more deposit prediction data sources 312a-312n.

In one or more embodiments, the digital deposit transaction prediction system 106 determines or receives various deposit transaction prediction data by utilizing and/or communicating with a deposit transaction predictor model data pipeline as described in application Ser. No. 18/153,703, the contents of which are herein incorporated by reference in their entirety.

As mentioned above, the digital deposit transaction prediction system 106 can utilize a deposit transaction predictor model to generate deposit transaction prediction data for user accounts of the inter-network facilitation system 104 (e.g., via a deposit transaction predictor data pipeline). For example, FIG. 4 illustrates a deposit transaction predictor data pipeline utilizing a deposit transaction predictor model. In particular, FIG. 4 illustrates the deposit transaction predictor data pipeline utilizing various types of user account data with a deposit transaction predictor model to output (or generate) deposit transaction prediction data (e.g., time-based and/or value-based deposit transaction prediction data).

As shown in FIG. 4, the deposit transaction predictor data pipeline provides user account data 402 to a deposit transaction predictor model 404. Indeed, as illustrated in FIG. 4, the user account data 402 can include, but is not limited to, historical deposit transaction data, deposit transaction source information, and client device data (e.g., from one or more data sources). As further shown in FIG. 4, the deposit transaction predictor data pipeline utilizes the user account data 402 with the deposit transaction predictor model 404 (which includes deposit transaction time predictor model and a deposit transaction value predictor model) to output (or generate) various deposit transaction prediction data 406.

In one or more embodiments, as shown in FIG. 4, the deposit transaction predictor data pipeline utilizes historical deposit transaction data from the user account data 402 for the deposit transaction predictor model 404. In one or more embodiments, the deposit transaction predictor data pipeline identifies historical deposit transaction data that indicate deposit transaction dates and/or amounts for deposit transactions that have occurred in the past for one or more user accounts. Indeed, the historical deposit transaction data can include known deposit transactions that indicate a monetary amount added (or deposited) into an account value of a user account. In one or more embodiments, the deposit transaction predictor data pipeline identifies a variety of historical deposit transactions for user accounts originating from transactions, such as, but not limited to, user deposited checks or electronic checks, peer-to-peer money transfers, refunds from various merchants or government agencies (e.g., a tax agency), user deposited checks from one or more employers (or businesses) of user of the user accounts, and/or direct deposit transactions from one or more employers (or businesses) of user of the user accounts. In some cases, the deposit transaction predictor data pipeline identifies and utilizes the historical transactions from user deposited checks from one or more employers (or businesses) of user of the user accounts and/or direct deposit transactions from one or more employers (or businesses) of user of the user accounts for the deposit transaction predictor model.

In some instances, as shown in FIG. 4, the deposit transaction predictor data pipeline utilizes deposit transaction source information from the user account data 402 for the deposit transaction predictor model 404. For example, the deposit transaction predictor data pipeline can identify deposit transaction source information for user accounts, such as, but not limited to, employer information (e.g., entity names, addresses, or contact information of employers) and/or self-employed business information (e.g., business names, addresses, or contact information of businesses operated and/or a source of income for users of the user accounts). In some cases, the deposit transaction predictor data pipeline can identify employer and/or business contact information for employment and/or ownership verification (e.g., verification emails and/or calls) of the employers and/or businesses (that are income sources for users of the user accounts). Indeed, the deposit transaction predictor data pipeline utilizes the deposit transaction source information to identify historical deposit transactions for the deposit transaction predictor model and/or as parameters in the deposit transaction predictor model to determine deposit transaction prediction data. Additionally, in some instances, the deposit transaction predictor data pipeline can identify deposit transaction source information to receive, from one or more third-party payroll systems, pay data corresponding to a user account (e.g., for the deposit transaction dates and/or amounts).

In some implementations, as shown in FIG. 4, the deposit transaction predictor data pipeline utilizes client device data from the user account data 402 for the deposit transaction predictor model 404. In some cases, the deposit transaction predictor data pipeline can utilize client device data, such as, but not limited to geo-locations of client devices corresponding to user accounts (e.g., via GPS, Wi-Fi, Bluetooth) and/or user activity times on various applications (or software) on client devices corresponding to user accounts. For example, in some instances, the deposit transaction predictor data pipeline utilizes geolocations of client devices with a deposit transaction predictor model to determine hours of employment (e.g., a number of hours users spend at places of employment) for the deposit transaction prediction data. In some cases, the deposit transaction predictor data pipeline utilizes user activity times on various applications or software (e.g., software and/or tools utilized by employers or businesses) while the applications or software are operated on client devices corresponding to the user accounts with a deposit transaction predictor model to determine hours of employment for the deposit transaction prediction data. Moreover, the deposit transaction predictor data pipeline can determine a predicted deposit transaction amount or an estimated deposit transaction amount earned so far from the determined hours of employment based on the geo-location and/or application activity times.

Although one or more embodiments illustrate the deposit transaction predictor data pipeline utilizing historical deposit transaction data, deposit transaction source information, and client device data for deposit transaction predictor models, the deposit transaction predictor data pipeline can utilize various other user account data. For example, the deposit transaction predictor data pipeline can utilize user data, such as, but not limited, user residence information, user employment information, and/or user provided income data. In some cases, the deposit transaction predictor data pipeline can utilize user account data, such as, but not limited to, user entered work hours for one or more employers and/or businesses corresponding to the user accounts.

Furthermore, as shown in FIG. 4, the deposit transaction predictor data pipeline can utilize the deposit transaction time predictor model from the deposit transaction predictor model 404 to generate (or determine) time-based deposit transaction prediction data 408 (using the user account data 402). As shown in FIG. 4, the time-based deposit transaction prediction data 408 includes predicted deposit transaction dates determined by the deposit transaction time predictor model using the user account data 402 that indicate predicted dates at which predicted deposit transactions will occur for various user accounts. Furthermore, as shown in FIG. 4, the time-based deposit transaction prediction data 408 includes predicted deposit transaction frequencies determined by the deposit transaction time predictor model using the user account data 402 that indicate predicted frequencies at which predicted deposit transactions will occur for various user accounts.

In some embodiments, the deposit transaction predictor data pipeline determines, via the deposit transaction time predictor model, one or more predicted dates for future deposit transactions in user accounts. For example, a predicted deposit transaction date can indicate a day or time of a predicted deposit transaction and/or a predicted date range for the future deposit transactions (e.g., within a range of days or a range of time). In some embodiments, the deposit transaction predictor data pipeline can determine, via the deposit transaction time predictor model, multiple predicted dates for multiple future deposit transactions in a user account (e.g., a determined or predicted schedule of predicted deposit transactions). Furthermore, in some cases, the deposit transaction predictor data pipeline, via the deposit transaction time predictor model, can determine a predicted deposit transaction frequency that indicates a predicted pattern for the predicted deposit transactions (e.g., a bi-weekly deposit, a semi-monthly deposit, a daily deposit). In one or more implementations, the deposit transaction predictor data pipeline can utilize the predicted deposit transaction frequency to determine a predicted shift for a user of a user account corresponding to the deposit transaction prediction data.

Moreover, as shown in FIG. 4, the deposit transaction predictor data pipeline can utilize the deposit transaction value predictor model to generate (or determine) value-based deposit transaction prediction data 410 (using the user account data 402). As shown in FIG. 4, the value-based deposit transaction prediction data 410 includes predicted deposit transaction amounts determined by the deposit transaction value predictor model using the user account data 402. Indeed, in one or more embodiments, the predicted deposit transaction amounts can indicate predicted monetary amounts that may be deposited in user accounts for predicted deposit transactions.

In one or more embodiments, the deposit transaction predictor data pipeline determines, via the deposit transaction value predictor model, one or more deposit transaction amount predictions for predicted deposit transactions as the value-based deposit transaction prediction data. For instance, a deposit transaction amount prediction can indicate a monetary amount (or account value) that may be deposited into a user account during a predicted deposit transaction. In some cases, the deposit transaction predictor data pipeline determines, via the deposit transaction value predictor model, multiple deposit transaction amount predictions for multiple deposit transaction predictions on different predicted deposit transaction dates. Moreover, in some cases, the deposit transaction predictor data pipeline utilizes the deposit transaction value predictor model to determine predicted amount ranges for the future deposit transactions (e.g., a range of a monetary amount predicted to occur during a predicted deposit transaction).

In some instances, as shown in FIG. 4, the deposit transaction predictor data pipeline also utilizes the deposit transaction predictor model to determine a predicted deposit transaction rate. For example, the deposit transaction predictor data pipeline can utilize a combination of predicted deposit transaction dates, predicted deposit transaction frequencies, and/or predicted deposit transaction amounts to determine a predicted deposit transaction rate for a user account. In particular, in one or more embodiments, the deposit transaction predictor data pipeline can determine a predicted deposit transaction rate that indicates a monetary amount that a user is predicted to receive within a specific time frame (e.g., per hour, per day, per month). Indeed, the deposit transaction predictor data pipeline can utilize a predicted deposit transaction frequency deposit with one or more predicted deposit transaction amounts to determine a predicted deposit transaction rate.

Furthermore, in one or more embodiments, the deposit transaction predictor data pipeline (and/or the digital deposit transaction prediction system 106) can determine available deposit balances for user accounts utilizing the deposit transaction prediction data. In particular, the deposit transaction predictor data pipeline (and/or the digital deposit transaction prediction system 106) can determine an available deposit balance for a user account that indicates or represents a deposit amount that the user account can access via a deposit transaction (e.g., at a time earlier than a predicted deposit transaction date). For instance, the deposit transaction predictor data pipeline (and/or the digital deposit transaction prediction system 106) can utilize the predicted deposit transaction amount as the available deposit balance.

Indeed, in one or more implementations, the digital deposit transaction prediction system 106 receives or determines the available deposit balance for a user account and modify the user account value based on the available deposit balance. For example, the digital deposit transaction prediction system 106 can modify a user account value of a user account to include the available deposit balance based on anticipation of the predicted deposit transaction at a future date (e.g., as an early pay or advance of the predicted deposit transaction). In some cases, the digital deposit transaction prediction system 106 can utilize the available deposit balance generated by the deposit transaction predictor data pipeline and/or utilize an available deposit balance determined using the deposit transaction prediction data as described below (e.g., in relation to FIG. 5).

In one or more implementations, the deposit transaction predictor data pipeline utilizes a heuristic (rule) based model for the deposit transaction time predictor model to predict (or determine) deposit transaction patterns (for the time-based deposit transaction prediction data). For example, the deposit transaction predictor data pipeline can identify and leverage patterns (e.g., date patterns) determined from historical deposit transaction dates, gaps between historical deposit transactions, deposit transaction source, and/or other user account data to determine a predicted deposit transaction date. In particular, the deposit transaction predictor data pipeline can utilize a deposit transaction time predictor model that maps or associates various historical deposit transaction dates, gaps between historical deposit transactions, deposit transaction source, and/or other user data to particular patterns (e.g., a repeating occurrence). In some cases, the deposit transaction time predictor model utilizes the historical deposit transaction dates, gaps between historical deposit transactions, deposit transaction source, and/or other user account data to project future dates for future deposit transactions (e.g., using a regression analysis or other forecasting tool).

In one or more embodiments, the deposit transaction predictor data pipeline utilizes various parameters for the deposit transaction time predictor model. In particular, the deposit transaction predictor data pipeline can utilize and/or modify various parameters, such as, but not limited to prediction time windows, time windows for historical deposit transactions, number of historical deposit transactions, and/or utilized data. For example, the deposit transaction predictor data pipeline can adjust a prediction time window by selecting or setting a range of accuracy (e.g., an error tolerance range) for a predicted deposit transaction date (e.g., a predicted date with a range of plus or minus 1 day, plus or minus 3 days, plus or minus 5 days). In some cases, the deposit transaction predictor data pipeline can adjust a time window for historical deposit transaction (e.g., using the last two months, three months, one month of historical deposit transaction data) and/or a number of historical deposit transaction (e.g., using the last four, five, six historical deposit transaction data). In some cases, the deposit transaction predictor data pipeline can determine to utilize or exclude various user account data in the deposit transaction time predictor model (e.g., excluding geo-location data or deposit transaction source information).

Moreover, in one or more embodiments, the deposit transaction predictor data pipeline utilizes the deposit transaction time predictor model to categorize predicted deposit transaction dates (or pattern) as a predicted deposit transaction frequency. For instance, the deposit transaction predictor data pipeline can determine a pattern or trend at which historical deposit transaction dates occur and/or a pattern or trend at which predicted deposit transaction dates occur. For example, the pattern or trend can represent a deposit transaction occurrence rate (e.g., every 2 weeks, every 30 days, every 15 days). Then, the deposit transaction predictor data pipeline can classify the determined pattern or trend within a particular predicted deposit transaction frequency category (e.g., bi-weekly, monthly, semi-monthly).

Additionally, in one or more embodiments, the deposit transaction predictor data pipeline utilizes a heuristic (rule) based model for the deposit transaction value predictor model to predict (or determine) deposit transaction patterns (for value-based deposit transaction prediction data). For instance, the deposit transaction predictor data pipeline can identify and leverage patterns (e.g., amount patterns) determined from historical deposit transaction amounts of historical deposit transactions and other user account data to determine a predicted deposit transaction amount. For instance, in some cases, the deposit transaction predictor data pipeline utilizes historical deposit transaction amounts of historical deposit transactions and other user account data with the deposit transaction value predictor model to determine averaged predicted deposit transaction amount. Moreover, in one or more embodiments, the deposit transaction predictor data pipeline utilizes a weighted average of the historical deposit transaction amounts of historical deposit transactions as a predicted deposit transaction amount. Although one or more embodiments describe the deposit transaction predictor data pipeline utilizing a deposit transaction value predictor model to determine averages for historical deposit transaction amounts of historical deposit transactions, the deposit transaction predictor data pipeline can utilize various statistical approaches, such as, but not limited to, medians, modes, minimums, maximums of the historical deposit transaction amounts of historical deposit transactions.

In some cases, the deposit transaction predictor data pipeline utilizes the historical deposit transaction amounts of historical deposit transactions and other user account data with the deposit transaction value predictor model to determine forecasted predicted deposit transaction amounts. For instance, the deposit transaction predictor data pipeline can utilize historical deposit transaction amounts to determine a trend or projection for the historical deposit transaction amounts and utilize the projection to determine a forecasted deposit transaction amount as the predicted deposit transaction amount. For instance, the deposit transaction predictor data pipeline can determine forecasted predicted deposit transaction amounts by utilizing a deposit transaction value predictor model that utilizes regression analysis and/or other statistic forecasting tools.

Furthermore, in some embodiments, the deposit transaction predictor data pipeline utilizes various parameters (or rules) for the deposit transaction value predictor model. For example, the deposit transaction predictor data pipeline can utilize and/or modify various parameters, such as, but not limited to prediction amount ranges, time windows for historical deposit transactions, number of historical deposit transactions, and/or utilized data. For example, the deposit transaction predictor data pipeline can adjust a prediction amount range by selecting or setting a range (e.g., an error tolerance range) for a predicted deposit transaction amount (e.g., a predicted amount with a range of plus or minus $100, plus or minus $50, plus or minus $200). In some cases, the deposit transaction predictor data pipeline can adjust a time window (e.g., as a rule) for historical deposit transaction, a number of historical deposit transaction, and/or utilize or exclude various user account data as described above.

In some cases, the deposit transaction predictor data pipeline can utilize weights for the historical deposit transactions as modifiable parameters for the deposit transaction value predictor model. For example, in one or more embodiments, the deposit transaction predictor data pipeline can assign weights to various historical deposit transactions based on various characteristics of the historical deposit transactions (e.g., age of the transaction, frequency of similar transactions, consistency of similar transactions). Then, the deposit transaction predictor data pipeline can utilize the weights to determine weighted averages (or other forecasts) for the historical deposit transaction amounts with the deposit transaction value predictor model to generate weight averaged (or other forecasted) deposit transaction amount predictions.

Furthermore, in one or more embodiments, the deposit transaction predictor data pipeline utilizes outlier detection logic as part of the deposit transaction value predictor model. For example, the deposit transaction predictor data pipeline determines or generates outlier detection logic as a modifiable parameter that controls or indicates historical deposit transaction amounts that will be excluded from consideration or analysis within the deposit transaction value predictor model. To illustrate, the deposit transaction predictor data pipeline can utilize outlier detection logic that identifies historical transaction deposit values that satisfy one or more threshold amount ranges. In particular, the deposit transaction predictor data pipeline can utilize outlier detection logic that excludes historical transaction deposit values that are greater than (or equal to) a maximum outlier value (e.g., a deposit transaction amount determined as substantially or abnormally high for a user account or user accounts) or less than (or equal to) a minimum outlier value (e.g., a deposit transaction amount determined as substantially or abnormally low for a user account or user accounts). In some cases, the deposit transaction predictor data pipeline can modify or adjust parameters of the outlier detection logic by adjusting or modifying the threshold amount ranges (e.g., maximum and/or minimum outlier values).

In some instances, the deposit transaction predictor data pipeline can utilize outlier detection logic to identify historical deposit transaction types that will be excluded from consideration or analysis within the deposit transaction value predictor model. For instance, the deposit transaction predictor data pipeline can identify that a historical deposit transaction does not correspond to a routine or reoccurring paycheck or income category (e.g., reimbursements, tax refunds, peer-to-peer payment, refunds). Moreover, upon identifying that a historical deposit transaction does not correspond to a routine or reoccurring paycheck or income category, the deposit transaction predictor data pipeline can exclude the identified historical deposit transaction from consideration or analysis within the deposit transaction value predictor model.

In some embodiments, the deposit transaction predictor data pipeline utilizes a machine learning based deposit transaction predictor model to determine deposit transaction prediction data. For instance, in one or more embodiments, the deposit transaction predictor data pipeline inputs user account data into the machine learning deposit transaction predictor model. Moreover, the machine learning deposit transaction predictor model analyzes the user account data to generate deposit transaction prediction data as an output. In some cases, the deposit transaction predictor data pipeline can utilize the machine learning deposit transaction predictor model to determine various deposit transaction prediction data, such as, the predicted deposit transaction dates, predicted deposit transaction frequencies, predicted deposit transaction amounts, predicted deposit transaction rate, available deposit balances, and/or confidence scores for the predicted data.

Furthermore, in one or more embodiments, the deposit transaction predictor data pipeline can utilize known deposit transaction data to validate or train a deposit transaction predictor model. For example, as shown in act 412 of FIG. 4, the deposit transaction predictor data pipeline utilizes known deposit transaction data 414 to run data validation of the deposit transaction prediction data 406. In particular, in the act 412, the deposit transaction predictor data pipeline utilizes known deposit transaction data 414 (e.g., from a third-party transaction data source or various other data sources) to validate the deposit transaction prediction data 406. For instance, the known deposit transaction data 414 can include known deposit transaction dates, amounts, available deposit balances, and/or frequencies.

Although one or more embodiments illustrate the digital deposit transaction prediction system 106 utilizing a deposit transaction predictor data pipeline that includes deposit transaction time predictor model and a deposit transaction value predictor model as the deposit transaction predictor model, the deposit transaction predictor data pipeline can utilize a singular deposit transaction predictor model to determine both time-based deposit transaction prediction data and value-based deposit transaction prediction data.

Moreover, as described in relation to FIG. 4, the digital deposit transaction prediction system 106 can determine (or receive) various deposit transaction prediction data, such as, the predicted deposit transaction dates, predicted deposit transaction frequencies, predicted deposit transaction amounts, predicted deposit transaction rate, available deposit balances, and/or confidence scores for the predicted data for one or more user accounts utilizing a deposit transaction predictor data pipeline (or digital deposit transaction modeling system) as described in application Ser. No. 18/153,703, the contents of which are herein incorporated by reference in their entirety.

As mentioned above, the digital deposit transaction prediction system 106 can determine an available deposit balance from deposit transaction prediction data corresponding to a user account. For example, the digital deposit transaction prediction system 106 can utilize deposit transaction prediction data with an available deposit balance model to determine an available deposit balance. Indeed, in some instances, the digital deposit transaction prediction system 106 can utilize an available deposit balance model that determines the available deposit balance directly from deposit transaction prediction data (e.g., predicted deposit transaction amounts). In certain implementations, the digital deposit transaction prediction system 106 utilizes an available deposit balance model to determine an amount range (or a categorized amount) for the available deposit balance based on the predicted deposit transaction amounts and user activities (or attributes) from the user account.

For example, FIG. 5 illustrates the digital deposit transaction prediction system 106 determining an available deposit balance for a user account from deposit transaction prediction data. In particular, FIG. 5 illustrates the digital deposit transaction prediction system 106 utilizing an available deposit balance model to determine an available deposit balance for a user account using various combinations of user activity data and/or predicted deposit transaction data. Indeed, as shown in FIG. 5, the digital deposit transaction prediction system 106 utilizes user activity data 502 and/or deposit transaction prediction data 504 as input for an available deposit balance model 506 to output an available deposit balance 516.

In one or more embodiments, the digital deposit transaction prediction system 106 can utilize user activity data that represents information associated with interactions of a user with one or more applications of the inter-network facilitation system 104 (or another system communicating with the inter-network facilitation system 104). For example, the user activity data can include actions, durations corresponding to actions, frequencies of actions, account values, and/or other representations of interactions of a user corresponding to a user account on a client application (e.g., operating a client application as shown in FIG. 1).

As illustrated in FIG. 5, the digital deposit transaction prediction system 106 can utilize various types of data (or variables) for the user activity data 502. For instance, as shown in FIG. 5, the user activity data 502 can include application utilization data. Indeed, the digital deposit transaction prediction system 106 can utilize application utilization data that indicates (historical) actions of a user account within one or more applications corresponding to the inter-network facilitation system 104 (as described in FIG. 1). As an example, the application utilize data can include, but is not limited to, a number of application logins, application features utilized by a user of a user account, and/or a frequency corresponding to the utilized features.

In addition, as shown in FIG. 5, the user activity data 502 can include available deposit balance utilization data. In particular, the digital deposit transaction prediction system 106 can utilize available deposit balance utilization data that indicates amounts and times (e.g., dates, times of day) that a user account has selected (or utilized) functionalities of historically displayed available deposit balances (e.g., past activity with selecting a pre-deposit transaction amount from historically surfaced/provided available deposit balance). In addition, the available deposit balance utilization data can also include, but not limited to, frequencies of utilization (e.g., how often a user account utilizes historical available deposit balances), user interaction activity (e.g., historical clicks, views) in GUIs displaying one or more functions for available deposit balances, and/or user account age (e.g., an amount of time a user account is active or enrolled within an application or service).

Furthermore, as shown in FIG. 5, the user activity data 502 can include transaction activity data. In some embodiments, the digital deposit transaction prediction system 106 identifies previous transactions with merchants, services, persons, employers, and/or other users of the inter-network facilitation system 104 as transaction activity data. In some cases, the digital deposit transaction prediction system 106 also identifies a transaction type (e.g., utilities, shopping, travel, fitness, reimbursements, paycheck, tax refund) associated with the transaction as part of the transaction activity data. In addition, the digital deposit transaction prediction system 106 can utilize various combinations of at least times corresponding to the transaction activity data (e.g., dates, time of days, time), the identity of the recipient or sender of the transaction, and/or transaction amounts as part of the transaction activity data. Although one or more embodiments illustrate transaction activity data of user accounts within the inter-network facilitation system 104, in some cases the digital deposit transaction prediction system 106 can identify transaction activity data from one or more other integrated user accounts from other transaction systems and/or transaction networks (e.g., third-party banking user accounts, money transfer application accounts) that are integrated or connected to a user account of the inter-network facilitation system 104.

Additionally, as shown in FIG. 5, the user activity data 502 can include client device data. For example, in one or more embodiments, the digital deposit transaction prediction system 106 can identify client device data that indicates information corresponding to a client device of a user and/or data determined by the client device. To illustrate, in some cases, the digital deposit transaction prediction system 106 can identify client device data, such as, but not limited to, a GPS location, a Wi-Fi connection, Bluetooth connection, and/or NFC connection (e.g., to determine a geolocation of the client device). Additionally, the client device data can include, but is not limited to, an operating system of the client device and/or screen time within various work applications (e.g., work or employer-based applications) on a client device (e.g., work email application, work document application).

Furthermore, as shown in FIG. 5, the user activity data 502 can include user verification data. In one or more embodiments, the digital deposit transaction prediction system 106 can identify user verification data that indicates proof and/or validation of information corresponding to the user account. For example, the user verification data can include data, such as, but not limited to, work location verification, work email verification, work phone number verification, and/or payroll provider account integration. For example, the digital deposit transaction prediction system 106 can, as user verification data, enable a user account to provide a work email and verify ownership of the work email (e.g., through a validation email). Moreover, the digital deposit transaction prediction system 106 can, as user verification data, enable a user account to connect to a payroll provider account as proof of employment and/or request confirmation from a payroll provider account for employment verification (e.g., via user authentication tokens, an API, and/or a verification email).

In addition, as shown in FIG. 5, the user activity data 502 can include deposit transaction source information. For example, the deposit transaction source information can include, but is not limited to, employer name, account information for deposit transaction party, pay stub data, business account name). Moreover, the deposit transaction source information can also include, but is not limited to, employer contact information and/or estimated income.

Additionally, as shown in FIG. 5, the digital deposit transaction prediction system 106 can also utilize the deposit transaction prediction data 504. For example, the digital deposit transaction prediction system 106 can identify the deposit transaction prediction data 504 in accordance with one or more implementations herein (e.g., as described in relation to FIGS. 3 and 4). Indeed, as described above, the deposit transaction prediction data can include, but is not limited to, predicted deposit transaction dates, predicted deposit transaction frequencies, predicted deposit transaction amounts, predicted deposit transaction rate, available deposit balances, and/or confidence scores for the predicted deposit transaction data.

Although one or more embodiments describe the digital deposit transaction prediction system 106 utilizing particular types of user activity data, the digital deposit transaction prediction system 106 can utilize various user activity data variables to determine a user account activity tier (or an available deposit balance). In particular, the digital deposit transaction prediction system 106 can utilize numerous variables (e.g., hundreds, thousands) corresponding to various categories such as, but not limited to, activity logs of user account sessions, user account balances, user account transactions, user account income and/or occupation information, geographic location information, user account contact information, and/or user account spending and/or transaction behaviors.

As further shown in FIG. 5, the digital deposit transaction prediction system 106 can utilize an available deposit balance model 506 to determine available deposit balances for user accounts by utilizing mappings between various combinations of the user activity data 502 and the deposit transaction prediction data 504. For instance, in relation to FIG. 5, the digital deposit transaction prediction system 106 can determine a user account activity tier 508 from the user activity data 502 and/or the deposit transaction prediction data 504 (within the available deposit balance model 506). Then, in relation to FIG. 5, the digital deposit transaction prediction system 106 can utilize the determined user account activity tier 508 with the deposit transaction prediction data 504 within an activity-to-deposit transaction prediction mapping 510 to determine a range for an available deposit balance (or an available deposit balance category) for a user account.

To illustrate, in some embodiments, the digital deposit transaction prediction system 106 determines a user account activity tier for a user account from the user activity data 502 (and the deposit transaction prediction data 504). For instance, the digital deposit transaction prediction system 106 can determine a user account activity tier as a value that indicates a rating (or category) for a user account. In particular, in some implementations, the user account activity tier represents (or indicates) a user activity level to categorize a user account into different levels of available deposit balances. Indeed, the digital deposit transaction prediction system 106 can utilize the user account activity tier to determine a maximum (or minimum) amount to utilize as an available deposit balance for the user account.

Moreover, in one or more embodiments, the digital deposit transaction prediction system 106 can utilize an activity tier model to determine a user account activity tier for a user account from user activity data (and/or deposit transaction prediction data). In some instances, the digital deposit transaction prediction system 106 utilizes a machine learning model (e.g., a user account activity tier machine learning model) with input user account activity data to determine a user account activity tier for a user account. In some implementations, the digital deposit transaction prediction system 106 utilizes a user account activity tier decision tree model to determine user account activity tier for a user account from user account activity data.

For example, the digital deposit transaction prediction system 106 can utilize a user account activity tier machine learning model that is trained to predict (or determine) user account activity tiers for a user account. In particular, the account activity tier machine learning model can analyze input user account activity data corresponding to a user account to generate (or predict) a user account activity tier for the user account.

Additionally, in certain instances, the digital deposit transaction prediction system 106 can train multiple user account activity tier machine learning models to specifically generate user account activity tiers for different types of user accounts (e.g., based on an age or activity duration corresponding to the user accounts). For instance, the digital deposit transaction prediction system 106 can train a user account activity tier machine learning model to emphasize (or function) for a specific set of user account activity data variables. In particular, the digital deposit transaction prediction system 106 can determine a set of user activity data variables to utilize for a particular user account activity tier machine learning model based on a duration of activity from a user account or other characteristic of a user account). In addition, in some implementations, the digital deposit transaction prediction system 106 can provide (or assign) weights to particular user activity data variables based on the duration of activity from a user account or other characteristic of a user account.

In some embodiments, the user account activity tier machine learning model includes a decision tree that generate probabilities for user activity tiers from various variables corresponding to various characteristics from user activity data. In one or more embodiments, the digital deposit transaction prediction system 106 utilizes the probabilities corresponding to the various user account activity tiers to select (or determine) an activity tier for the user account. Indeed, the digital deposit transaction prediction system 106 can utilize a decision tree model that includes various user activity data variables that branch based on user activity data satisfying (or not satisfying) the thresholds generated for the various user activity data variables (e.g., within the decision tree). Subsequently, based on satisfying (or not satisfying) the thresholds corresponding to the user activity data variables, the digital deposit transaction prediction system 106 can determine the effect the branching user activity data variables contributes to a probability or score corresponding to a user activity tier.

To illustrate, the digital deposit transaction prediction system 106 can utilize a decision tree model to determine whether data of a user account (e.g., activity data) satisfies a threshold for a first node of the decision tree. Based on whether the user account satisfies the threshold for the first node, the digital deposit transaction prediction system 106 can track a user activity tier probability for the user account and further traverse to subsequent nodes to check other user activity data variables. Moreover, at each node of the decision tree, the digital deposit transaction prediction system 106 can adjust the user activity tier probability corresponding to the user account based on whether the user account activity data satisfies the thresholds for the user activity data variable at the particular node.

As an example, at a first node of the decision tree, the digital deposit transaction prediction system 106 can identify whether an application utilization time of a user account has been above a threshold number of days. In some instances, upon determining that the application utilization time of the user account does satisfy the threshold number of days, the digital deposit transaction prediction system 106 can subsequently traverse to a node of the decision tree that increases the probability of the user account belonging to a particular user account activity tier. On the other hand, upon determining that the application utilization time of the user account does not satisfy the threshold number of days, the digital deposit transaction prediction system 106 can subsequently traverse to a node of the decision tree that decreases the probability of the user account belonging to the particular user account activity tier. In addition, the digital deposit transaction prediction system 106 can further analyze another user activity data variable at the subsequent nodes to further determine increases (and/or decreases) in probabilities for the user account for particular user account activity tiers.

In some embodiments, the digital deposit transaction prediction system 106 outputs, through the user activity tier model, a user account activity tier as a numerical value for the user account. For instance, the digital deposit transaction prediction system 106 can utilize a user account activity tier between zero and four. In particular, the digital deposit transaction prediction system 106 can utilize the user account activity tier of zero to four to indicate varying accessibilities to available deposit balance ranges to the user account. For instance, a user account activity tier of zero can be associated with a lower range of available deposit balance ranges while a user account activity tier of six can be associated with a higher range of available deposit balance ranges.

In some embodiments, the user account activity tier can be represented using various numerical values and/or other types of data to indicate a category for a user account. For example, the user account activity tier can include an alphabetical grade, a percentage, class, and/or a label. Furthermore, although one or more embodiments describe the digital deposit transaction prediction system 106 utilizing a user account activity tier decision tree model, the digital deposit transaction prediction system 106 can utilize various machine learning models to generate (or predict) a user account activity tier for a user account. For example, the digital deposit transaction prediction system 106 can utilize a classification neural network to classify a user account into a user account activity tier based on one or more user activity data variables. In some instances, the digital deposit transaction prediction system 106 can utilize a regression-based and/or clustering-based machine learning models to determine a user account activity tier for a user account based on one or more user activity data variables.

As previously mentioned and as shown in FIG. 5, the digital deposit transaction prediction system 106 can determine the available deposit balance 516 (or an available deposit balance range) from the available deposit balance model 506 using a determined user account activity tier and activity-to-deposit transaction prediction mapping 510. In particular, the digital deposit transaction prediction system 106 can utilize the user account activity tier 508 determined for the user account and the deposit transaction prediction data 504 to select one or more available deposit balance amounts as the available deposit balance 516. As shown in FIG. 5, the digital deposit transaction prediction system 106 utilizes an activity-to-deposit transaction prediction mapping 510 (e.g., as a matrix-based model) to determine one or more available deposit balances for a user account.

As further shown in FIG. 5, the digital deposit transaction prediction system 106 utilizes the user account activity tier 508 select a set of candidate available deposit balance amounts (e.g., a row corresponding to a particular user account activity tier). Moreover, the digital deposit transaction prediction system 106 can reference the predicted deposit transaction amount for the user account (determined as described above) with the determined user account activity tier to select a particular available deposit balance. As an example, upon determining a user activity tier of 4 and a predicted deposit transaction amount of “D” (e.g., “D” can include various range values for deposit transaction amounts, such as 0-100 dollars, 200-400 dollars, 401-700 dollars, 701-1500 dollars, 1501-2001 dollars), the digital deposit transaction prediction system 106 can utilize an available deposit balance value of 500. As another example, upon determining a user activity tier of 0 and a predicted deposit transaction amount of “A” (e.g., deposit transaction amount of 0), the digital deposit transaction prediction system 106 can utilize an available deposit balance value of 5.

In one or more embodiments, the digital deposit transaction prediction system 106 can select an available deposit balance value from the available deposit balance model mapping as a maximum available deposit balance (for an available deposit balance range). For instance, upon selecting 500 as the available deposit balance, the digital deposit transaction prediction system 106 can utilize a range of 0 to 500 as the available deposit balance. As another example, upon selecting 300 as the available deposit balance, the digital deposit transaction prediction system 106 can utilize a range of 0 to 300 as the available deposit balance.

Moreover, in certain implementations, the digital deposit transaction prediction system 106 can utilize the selected available deposit balance value from the available deposit balance model mapping as an incremental value. For instance, the digital deposit transaction prediction system 106 can determine and provide the available deposit balance value to a user account from the available deposit balance model mapping. In addition, the digital deposit transaction prediction system 106 can determine the subsequent available deposit balance in the available deposit balance model mapping for the user account and one or more conditions (e.g., user activities and/or deposit transaction amounts) to reach the subsequent available deposit balance. Indeed, the digital deposit transaction prediction system 106 can provide, for display within a GUI of a client device, the available deposit balance, a subsequent available deposit balance, and the one or more conditions to achieve the subsequent available deposit balance.

In one or more embodiments, the digital deposit transaction prediction system 106 can utilize a deposit transaction prediction mapping without a user account activity tier. For example, the digital deposit transaction prediction system 106 can utilize a matrix-based table that maps various predicted deposit transaction amounts to incremental available deposit balances. For instance, the digital deposit transaction prediction system 106 can map a first deposit transaction prediction range to a first (maximum) available deposit balance and map a second deposit transaction prediction range to a second (maximum) available deposit balance.

In some implementations, the values associated with available deposit balance model (e.g., activity-to-deposit transaction prediction mapping matrix and/or the matrix-based table mapping predicted deposit transaction amounts to incremental available deposit balances) can be generated (or populated) utilizing a machine learning model. As an example, the digital deposit transaction prediction system 106 can train a machine learning model (e.g., a decision tree model, a regression model, a classification model) to determine (or predict) available deposit balance for varying user account activity tiers and/or deposit transaction prediction data (e.g., mappings that are likely to result in higher rate of utilization and requests of the available deposit balance from user accounts). Then, the digital deposit transaction prediction system 106 can utilize the machine learning model to generate the available deposit balance model by populating data values of an available deposit balance matrix based on predicted mappings between user activity tiers, the predicted deposit transaction amounts, and/or one or more user activities.

Moreover, in one or more embodiments, the values corresponding to the available deposit balance model can be configured and/or modified by an administrator user on an administrator device. For instance, the digital deposit transaction prediction system 106 can receive a selection and/or input value for a particular value or element within available deposit balance model. Then, the digital deposit transaction prediction system 106 can utilize the selection and/or input to modify a mapping between predicted mappings between user activity tiers, the predicted deposit transaction amounts, and/or one or more user activities within the available deposit balance model.

As further shown in FIG. 5, in some implementations, the digital deposit transaction prediction system 106 can utilize a modifier 514 with a predicted deposit transaction amount 512 (from the deposit transaction prediction data 504) to determine the available deposit balance 516. For example, the digital deposit transaction prediction system 106 can determine a modifier (e.g., as a percentage) for the user account based on user activity data corresponding to the user account. In some cases, the digital deposit transaction prediction system 106 utilizes a determined user account activity tier (as described above) to assign a modifier for the user account as the modifier 514 (e.g., 1% for a user account activity tier of 0, 10% for a user account activity tier of 1, 30% for a user account activity tier of 4). Then, the digital deposit transaction prediction system 106 can utilize the modifier 514 with the predicted deposit transaction amount 512 to determine the available deposit balance 516 by determining the determined percent from the modifier of the predicted deposit transaction amount (e.g., 10% of a predicted deposit transaction of $1000, 30% of a predicted deposit transaction amount of $2000).

In some implementations, the digital deposit transaction prediction system 106 determines an available deposit balance for a user account by using a predicted deposit transaction rate for the user account with a historical transaction date from the user account. In particular, the digital deposit transaction prediction system 106 determines the most previous deposit transaction date occurring on the user account (e.g., for a direct deposit corresponding to an employer or business income payment). Then, the digital deposit transaction prediction system 106 utilizes the predicted deposit transaction rate with the most previous deposit transaction date to determine an available deposit balance for the user account corresponding to the amount of time that has been covered between the most previous deposit transaction date and a subsequent predicted deposit transaction date.

As an example, the digital deposit transaction prediction system 106 can determine that a previous deposit transaction occurred on October 1^{st} and that the subsequent predicted deposit transaction date is on October 10^{th}. As part of the above-mentioned example, the digital deposit transaction prediction system 106 can, on October 5^{th}, determine that 5 days (e.g., earned time) have passed between the previous deposit transaction and the subsequent predicted deposit transaction date. Accordingly, the digital deposit transaction prediction system 106 can utilize the earned time (e.g., 5 days) with the predicted deposit transaction rate to determine an available deposit balance. To further the example above, if the predicted deposit transaction rate is determined to be $10 a day, the digital deposit transaction prediction system 106 can determine that the user account has an available deposit balance of $50 using the earned time (e.g., 5 days) between the most previous deposit transaction date and a subsequent predicted deposit transaction date.

In some implementations, the digital deposit transaction prediction system 106 utilizes client device data from the user account data to determine an available deposit balance. In some cases, the digital deposit transaction prediction system 106 can utilize client device data, such as, but not limited to geo-locations of client devices corresponding to user accounts (e.g., via GPS, Wi-Fi, Bluetooth) and/or user activity times on various applications (or software) on client devices corresponding to user accounts. For example, in some instances, the digital deposit transaction prediction system 106 utilizes geolocations of client devices to determine hours of employment (e.g., a number of hours users spend at places of employment). In some cases, the digital deposit transaction prediction system 106 utilizes user activity times on various applications or software (e.g., software and/or tools utilized by employers or businesses) while the applications or software are operated on client devices corresponding to the user accounts to determine hours of employment. Subsequently, the digital deposit transaction prediction system 106 can utilize the determined hours (or other time rate) with a predicted deposit transaction rate (e.g., from the deposit transaction predictor model data pipeline) to determine an available deposit balance (as the amount predicted to be earned based on identified hours).

In one or more instances, the digital deposit transaction prediction system 106 receives an available deposit balance from the deposit transaction predictor model data pipeline. For instance, the digital deposit transaction prediction system 106 can receive an available deposit balance for a user account as determined by the deposit transaction predictor model data pipeline. Then, the digital deposit transaction prediction system 106 can utilize the received available deposit balance as a maximum available deposit balance (for an available deposit balance range) to display within a GUI of a client device corresponding to the user account.

Additionally, in some embodiments, the digital deposit transaction prediction system 106 can determine one or more available deposit balances from deposit transaction prediction data for various numbers of deposit transaction sources corresponding to a user account. For example, the digital deposit transaction prediction system 106 can determine one or more available deposit balances from deposit transaction prediction data for multiple, separate deposit transaction sources (e.g., multiple income sources) determined on the deposit transaction predictor model data pipeline. To illustrate, the digital deposit transaction prediction system 106 can receive, from the deposit transaction predictor model data pipeline, time-based deposit prediction data and/or value-based deposit prediction data for separate deposit transaction sources for a user account.

Subsequently, the digital deposit transaction prediction system 106 can utilize the deposit transaction prediction data for multiple, separate deposit transaction sources (e.g., multiple income sources) to determine one or more available deposit balances. For instance, in some cases, the digital deposit transaction prediction system 106 can utilize a maximum available deposit balance from multiple available deposit balances obtains from the multiple deposit transaction prediction amounts for the multiple, separate deposit transaction sources (e.g., multiple income sources). In other cases, the digital deposit transaction prediction system 106 can combine the multiple deposit transaction prediction amounts for the multiple, separate deposit transaction sources (e.g., multiple income sources) and utilize the combined deposit transaction prediction amount to determine an aggregated available deposit balance (e.g., an available deposit balance that accounts for the combined multiple deposit transaction prediction amounts).

Moreover, although one or more embodiments herein illustrate the digital deposit transaction prediction system 106 utilizing deposit transaction prediction data to determine an available deposit balance, the digital deposit transaction prediction system 106 can, in some instances, utilize data from a third-party payroll system (and/or payroll account). For instance, the digital deposit transaction predictions system 106 can request payroll data (e.g., a next deposit amount and/or deposit date for pay corresponding to a user) from the third-party payroll system (e.g., via an API). Indeed, in one or more embodiments, the digital deposit transaction prediction system 106 can enable integration (or connection) of a payroll account within a user account of the inter-network facilitation system 104 to receive payroll data (e.g., a next deposit amount and/or deposit date for pay corresponding to a user) from the third-party payroll system.

As mentioned above, the digital deposit transaction prediction system 106 can display a dynamic available deposit balance (e.g., based on predicted deposit transaction data) within a GUI and modify user account values based on user selections corresponding to the available deposit balance. For instance, FIGS. 6A-6F illustrate the digital deposit transaction prediction system 106 utilizing determined available deposit balances (from predicted deposit transaction data), as described above, to generate dynamic GUIs that enable access to the determined available deposit balances prior to an occurrence of a predicted deposit transaction. Furthermore, FIGS. 6A-6F illustrate the digital deposit transaction prediction system 106 utilizing user selected pre-deposit transaction amounts based on the available deposit balance to modify user account values.

For instance, FIG. 6A illustrates the digital deposit transaction prediction system 106 providing, within a GUI 604 of a client device 602, a determined available deposit balance and selectable options to access the available deposit balance. Indeed, as shown in FIG. 6A, the digital deposit transaction prediction system 106 provides, within the GUI 604, a user account value 606 within an application of the inter-network facilitation system 104. Moreover, as shown in FIG. 6A, upon determining an available deposit balance (in accordance with one or more embodiments herein), the digital deposit transaction prediction system 106 displays (or provides for display) the available deposit balance 608 within the GUI 604. Furthermore, as shown in FIG. 6A, the digital deposit transaction prediction system 106 also provides, for display within the GUI 604, value-based predicted deposit transaction data that indicates predicted earnings 610 (e.g., an indicator to represent earned predicted deposit transaction amount based on a predicted deposit transaction rate) for the user account. Moreover, as shown in FIG. 6A, the digital deposit transaction prediction system 106 also provides, for display within the GUI 604, a selectable option 612 to access information and options for the available deposit balance 608.

Furthermore, as shown in the transition from FIG. 6A to FIG. 6B, upon receiving (or detecting) a user selection of the selectable option 612, the digital deposit transaction prediction system 106 provides, for display within a GUI 614 in the client device 602, information and options for the available deposit balance 608. In particular, as shown in FIG. 6B, the digital deposit transaction prediction system 106 provides, for display within the GUI 614, the available deposit balance 608 and the predicted earnings 610 for the user account. In addition, as shown in FIG. 6B, the digital deposit transaction prediction system 106 provides, for display within the GUI 614, historical deposit transactions 616 identified in the user account. Moreover, as also shown in FIG. 6B, the digital deposit transaction prediction system 106 provides, for display within the GUI 614, a selectable option 618 to access functions to select a pre-deposit transaction amount (as described above) in relation to the available deposit balance 608.

To illustrate, as shown in the transaction from FIG. 6B to FIG. 6C, the digital deposit transaction prediction system 106 provides, for display within a GUI 620 in the client device 602, selectable options to select a pre-deposit transaction amount from the available deposit balance 608 upon receiving (or detecting) a user selection of the selectable option 618. For example, as shown in FIG. 6C, the digital deposit transaction prediction system 106 provides, for display within the GUI 620, an indicator 622 that indicates a selected pre-deposit transaction amount. For instance, the digital deposit transaction prediction system 106 can detect inputs in the selectable number pad within the GUI 620 to update the indicator 622 (e.g., as a selected pre-deposit transaction amount). In addition, the digital deposit transaction prediction system 106 provides, within the GUI 620, a limiter 624 as an indication of the maximum range of selection for the pre-deposit transaction amount in the user account (e.g., as the determined available deposit balance).

In one or more embodiments, the digital deposit transaction prediction system 106 receives various selected amounts within the GUI 620 as pre-deposit transaction amounts. For instance, the pre-deposit transaction amount selection can be within the range of the determined available deposit balance. In some instance, the selected pre-deposit transaction amount can be the entire available deposit balance. Furthermore, in one or more embodiments, upon selection of an option to access an available deposit balance, the digital deposit transaction prediction system 106 automatically provides the entire available deposit balance value as the pre-deposit transaction amount.

Moreover, as shown in the transition from FIG. 6C to FIG. 6D, the digital deposit transaction prediction system 106 can update (modify) user account values of the user account based on a selected pre-deposit transaction amount. For instance, as shown in FIG. 6D, upon detecting (or receiving) a pre-deposit transaction amount selection of $60 (within the GUI 620), the digital deposit transaction prediction system 106 modifies and displays the user account value 626 (within the GUI 604 on the client device 602). Indeed, as shown in FIG. 6D, the user account value 626 includes the selected pre-deposit transaction amount 628 (e.g., as part of funds for the user account). Moreover, as shown in FIG. 6D, the digital deposit transaction prediction system 106 provides, for display within the GUI 604, an updated available deposit balance 630 that reflects actions taken on the user account (e.g., an available deposit balance of 0 because the entire available deposit balance amount from the available deposit balance 608 is selected as the pre-deposit transaction amount).

Addition, as shown in FIG. 6D, the digital deposit transaction prediction system 106 provides, for display within the GUI 604, a selectable option 632 to access information and options for the updated available deposit balance 642. Indeed, as shown in the transition from FIG. 6D to FIG. 6E, upon receiving (or detecting) a user selection of the selectable option 632, the digital deposit transaction prediction system 106 provides, for display within the GUI 614 in the client device 602, information for the updated available deposit balance 642. In particular, as illustrated in FIG. 6E, the digital deposit transaction prediction system 106 provides, for display within the GUI 614, an indication that the available deposit balance 630 is 0 (e.g., due to the previous user selected pre-deposit transaction amount). In addition, as shown in FIG. 6E, the digital deposit transaction prediction system 106 provides, for display within the GUI 614, a notification 634 that indicates that an additional available deposit balance (e.g., a get paid early amount) will be available upon receiving a subsequent qualifying deposit transaction (e.g., a direct deposit).

In addition, as shown in FIG. 6E, the digital deposit transaction prediction system 106 also provides, for display within the GUI 614, a deposit transaction history 636. For example, the deposit transaction history 636 includes a previously accessed (or obtained) available deposit balance (e.g., a get paid early amount) and a previous deposit transaction (e.g., a direct deposit). Indeed, the deposit transaction history 636 can include various deposit transactions for the user account.

In some cases, the digital deposit transaction prediction system 106 receives a user selection of a pre-deposit transaction amount that is a partial amount of the available deposit balance (e.g., less than the available deposit balance). Upon receiving a user selection of the pre-deposit transaction amount that is a partial amount, the digital deposit transaction prediction system 106 can update (or modify) a user account value to include the partial amount while providing selectable options for continued access to the remaining available deposit balance prior to the next deposit transaction. For instance, the digital deposit transaction prediction system 106, upon receiving a user selection to access the available deposit balance after selecting a partial amount as the pre-deposit transaction amount and prior to a subsequent deposit transaction, the digital deposit transaction prediction system 106 can display the remaining available deposit balance and provide selectable options to select an additional pre-deposit transaction amount for the entire remaining available deposit balance (or an additional portion of the remaining available deposit balance).

Moreover, upon receiving a subsequent deposit transaction, the digital deposit transaction prediction system 106 can update a user account to include the subsequent deposit transaction modified by previously accessed available deposit balances. To illustrate, as shown in the transition from FIG. 6E to FIG. 6F, the digital deposit transaction prediction system 106 can receive and display, within the GUI 604 of the client device 602, a deposit transaction 640 and modify the user account 638 (e.g., to include the deposit transaction 640). Moreover, due to the previously selected available deposit balance (as the pre-deposit transaction amount 628), the digital deposit transaction prediction system 106 modifies the deposit transaction 640 such that the original received amount is modified to deduct the previously selected pre-deposit transaction amount 628 (e.g., $60 deducted from the original received amount of $570 to result in a deposit transaction of $510).

Additionally, upon receiving a subsequent deposit transaction, the digital deposit transaction prediction system 106 can update available deposit balances for future predicted deposit transactions. For example, as shown in FIG. 6F, the digital deposit transaction prediction system 106 determines an updated available deposit balance (in accordance with one or more embodiments herein) and displays (or provides for display) an updated available deposit balance 642 within the GUI 604. Furthermore, as shown in FIG. 6F, the digital deposit transaction prediction system 106 also provides, for display within the GUI 604, value-based predicted deposit transaction data that indicates predicted earnings 644 (e.g., an indicator to represent earned predicted deposit transaction amount based on a predicted deposit transaction rate) for the user account from a time of the deposit transaction 640. Moreover, as shown in FIG. 6F, the digital deposit transaction prediction system 106 also provides, for display within the GUI 604, a selectable option 646 to access information and options for the updated available deposit balance 642.

In one or more embodiments, the digital deposit transaction prediction system 106 can provide, for display within a graphical user interface of a client device, various types of available deposit balances and selectable options for the available deposit balances. For instance, in some cases (as illustrated in FIGS. 6A-6F), the digital deposit transaction prediction system 106 provides incremental available deposit balances (or a categorical available deposit balance) determined from an available deposit balance model as described above (e.g., in relation to FIG. 5). Moreover, in some instances, the digital deposit transaction prediction system 106 provides available deposit balances based directly on predicted deposit transaction amounts as described above (e.g., in relation to FIG. 5).

Moreover, in one or more embodiments, the digital deposit transaction prediction system 106 can track subsequent deposit transactions to determine whether a predicted deposit transaction is fulfilled. In some cases, upon determining (or identifying) an absence of the subsequent deposit transaction(s) for a threshold number of days, the digital deposit transaction prediction system 106 can disable access to an available deposit balance to the user account and/or reduce the available deposit balance. For example, upon determining that a predicted deposit transaction did not occur on or after a number of threshold days, the digital deposit transaction prediction system 106 can disable selectable options to access an available deposit balance. In some cases, the digital deposit transaction prediction system 106 also reduces (or sets to zero) subsequent available deposit balances for the user account.

In some implementations and as mentioned above, the digital deposit transaction prediction system 106 updates available deposit balances (including estimated earnings) using the deposit transaction predictor model data pipeline. For instance, the digital deposit transaction prediction system 106 can frequently (e.g., daily, weekly, hourly, monthly) request updated predicted deposit transaction data (e.g., predicted deposit transaction dates, predicted deposit transaction frequencies, predicted deposit transaction amounts, predicted deposit transaction rate, available deposit balances, confidence scores) from the deposit transaction predictor model data pipeline. Then, the digital deposit transaction prediction system 106 can provide, within a graphical user interface of a client device, updated available deposit balances and/or other estimated earnings data utilizing the updated predicted deposit transaction data in accordance with one or more embodiments herein.

In some cases, the digital deposit transaction prediction system 106 can determine and provide, for display within a GUI, estimated earnings data. For example, the digital deposit transaction prediction system 106 can determine the most previous deposit transaction date occurring on the user account. Then, the digital deposit transaction prediction system 106 can utilize the predicted deposit transaction rate with the most previous deposit transaction date to determine estimated earnings for the user account corresponding to the amount of time that has been covered between the most previous deposit transaction date and a subsequent predicted deposit transaction date. As described above, in some cases, the digital deposit transaction prediction system 106 utilizes the estimated earnings as the available deposit balance for the user account.

Additionally, in some embodiments, the digital deposit transaction prediction system 106 can provide, for display within a GUI, an available deposit balance and/or information for the available deposit balance for an available deposit balance that is determined from deposit transaction prediction data corresponding to multiple deposit transaction sources corresponding to a user account. In particular, the digital deposit transaction prediction system 106 can provide, for display within a GUI, a combined available deposit balance (or multiple available deposit balances) determined from multiple, separate deposit transaction sources (e.g., multiple income sources) in accordance with one or more implementations herein. Furthermore, the digital deposit transaction prediction system 106 can provide, for display within the GUI, information for the multiple, separate deposit transaction sources (e.g., multiple income sources).

Although not shown in FIGS. 6A-6F, in some embodiments, the digital deposit transaction prediction system 106 can provide, for display within a GUI of a client device, one or more informational pages and/or interfaces that describe various conditions and/or terms for accessing displayed available deposit balances. For instance, the digital deposit transaction prediction system 106 can display informational pages and/or interfaces that indicate or describe one or more costs and/or service fees associated with the displayed available deposit balances. In some cases, the digital deposit transaction prediction system 106 can display informational pages and/or interfaces that include terms and conditions for using and/or receiving the displayed available deposit balances. In some cases, the digital deposit transaction prediction system 106 can provide, within displayed informational pages and/or interfaces, one or more selectable options to receive a user confirmation from a user of a user account (e.g., a confirm button for the displayed information in the informational pages and/or interfaces as described above).

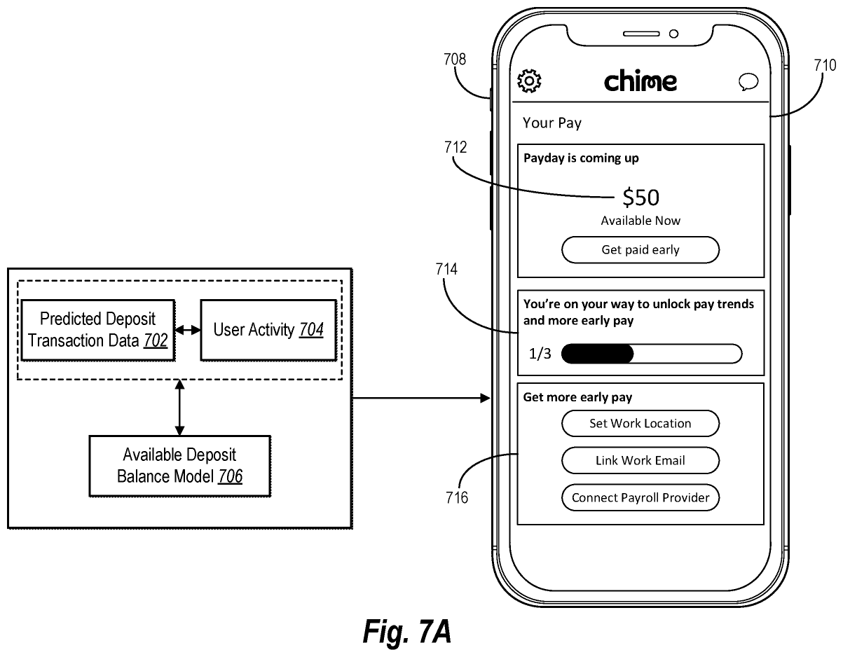

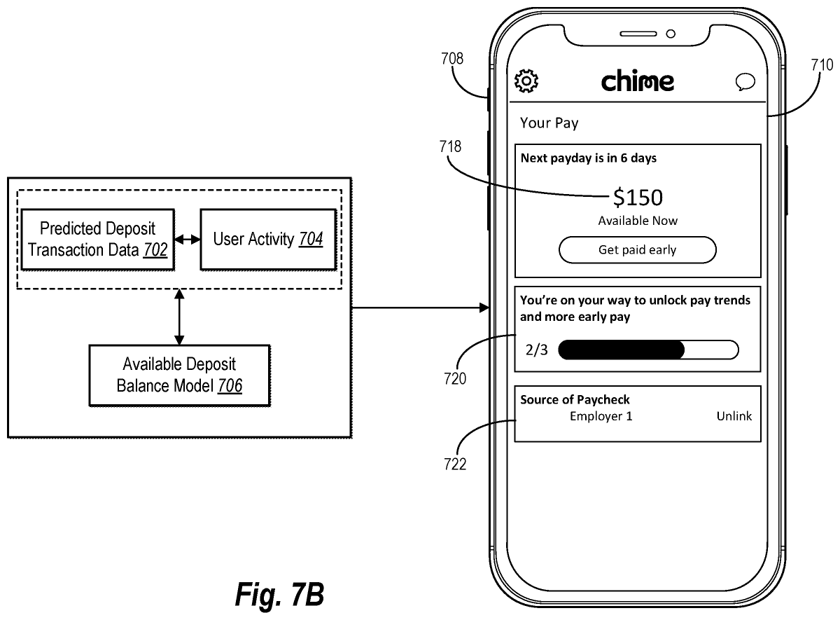

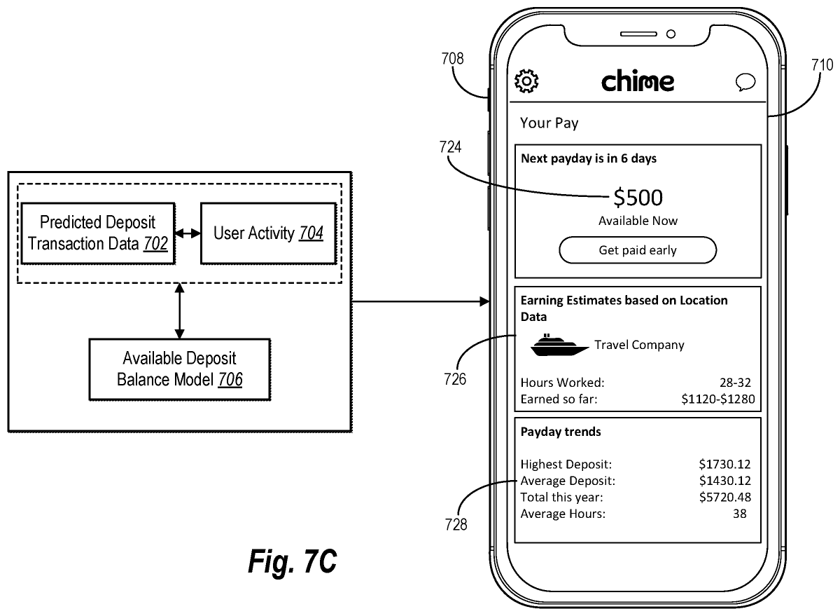

As mentioned above, the digital deposit transaction prediction system 106 can update available deposit balances, within GUIs of client devices, based on updated outputs from an available deposit balance model using updated predicted deposit transaction data and/or updated user activity data. For instance, FIGS. 7A-7C illustrate the digital deposit transaction prediction system 106 utilizing an available deposit balance model (as described in FIG. 5) to determine and update displayed available deposit balances. In addition, FIGS. 7A-7C also illustrate the digital deposit transaction prediction system 106 providing, for display within a GUI of a client device, selectable user activity options that cause the performance of particular user activities and, subsequently, update an available deposit balance.

In particular, as shown in FIG. 7A, the digital deposit transaction prediction system 106 provides, for display within a GUI 710 of a client device 708, an available deposit balance 712. In addition (as shown in FIG. 7A), the digital deposit transaction prediction system 106 provides, for display within the GUI 710, a progress indicator 714 that tracks and presents various user activities of a user account that will likely affect subsequent available deposit balances (in an available deposit balance model 706). Indeed, in some cases, the digital deposit transaction prediction system 106 can determine a user activity performed by a user account (from another component or location of a client application corresponding to the inter-network facilitation system 104). In one or more embodiments, as shown in FIG. 7A, the digital deposit transaction prediction system 106 determines or detects a user activity performed by the user account based on a user interaction with one or more selectable user activity options.

To illustrate, as shown in FIG. 7A, the digital deposit transaction prediction system 106 provides, for display within the GUI 710, selectable user activity options 716. Indeed, as shown in FIG. 7A, the selectable user activity options 716 include an option to set a work location, an option to link a work email, and an option to connect a payroll provider to the user account. Indeed, upon receiving a user selection of one or more of the options from the selectable user activity options 716, the digital deposit transaction prediction system 106 enables the client device to provide one or more functionalities to setup a work location, link (and verify) a work email, and/or connect (or integrate) a payroll provider to the user account. Indeed, upon identifying completion of the one or more selectable user activity options 716, the digital deposit transaction prediction system 106 can utilize the available deposit balance model 706 to update (e.g., increase) the available deposit balance for the user account.

Although FIG. 7A illustrates particular user activity options, the digital deposit transaction prediction system 106 can provide options for various user activities (e.g., user activities described in reference to FIG. 5). For example, in some cases, the digital deposit transaction prediction system 106 can provide, for display, a selectable option to integrate (or connect) another user account (associated with the user of the user account) from other transaction systems and/or transaction networks (e.g., third-party banking user accounts, money transfer application accounts). Additionally, in some implementations, the digital deposit transaction prediction system 106 can provide, for display, a selectable option to link (and verify) a work phone number.

Moreover, upon completion of one or more user activities, the digital deposit transaction prediction system 106 can update an available deposit balance and a user activity progress tracker. For instance, as shown in the transition from FIG. 7A to FIG. 7B, the digital deposit transaction prediction system 106 can provide, for display within the GUI 710 of the client device 708, an updated presented progress indicator 720 to indicate an additional completed user activity (e.g., connecting a payroll provider). Additionally, as shown in FIG. 7B, the digital deposit transaction prediction system 106 can utilize the completed one or more user activities as part of the user activity 704 (with the predicted deposit transaction data 702) to generate an updated available deposit balance 718 from the available deposit balance model 706.

Additionally, as shown in FIG. 7B, upon completing the user activity of connecting a payroll provider (from the selectable user activity options 716 of FIG. 7A), the digital deposit transaction prediction system 106 provides, for display within the GUI 710 of the client device 708, information indicator 722 for the connected payroll provider. Indeed, the information indicator 722 indicates a deposit transaction source utilized for the available deposit balance 718. In addition, the digital deposit transaction prediction system 106 provides, as part of information indicator 722, a selectable option to unlink the deposit transaction source (e.g., remove Employer 1 as a linked deposit transaction source). Upon unlinking, the digital deposit transaction prediction system 106 can reduce the available deposit balance of the user account based on removal of a user activity within the available deposit balance model 706. In one or more embodiments, the information indicator 722 includes multiple deposit transaction source linked to the user account.

In addition, as shown in the transition from FIG. 7B to FIG. 7C, the digital deposit transaction prediction system 106 can provide, for display within the GUI 710 of the client device 708, an information indicator 726 for an additional completed user activity (e.g., setting work location as shown in the selectable options 716 of FIG. 7A). Additionally, as shown in FIG. 7C, the digital deposit transaction prediction system 106 can utilize the completed one or more user activities as part of the user activity 704 (with the predicted deposit transaction data 702) to generate an updated available deposit balance 724 from the available deposit balance model 706 (e.g., an increase from the available deposit balance 718).

Additionally, as shown in FIG. 7C, upon completing the user activity of setting a work location (from the selectable options 716 of FIG. 7A), the digital deposit transaction prediction system 106 provides, for display within the GUI 710 of the client device 708, information indicator 726 for estimated earnings based on geo-location (e.g., an indicator to represent earned predicted deposit transaction amount). Indeed, the information indicator 726 indicates employer information for the user account and utilizes geo-location data to indicate a number of hours (or range of hours) in which the digital deposit transaction prediction system 106 detected the client device 708 at a work location corresponding to the employer (e.g., “travel company”). As shown in FIG. 7C, the digital deposit transaction prediction system 106 provides, as part of information indicator 726, a number of hours spent at the work location (e.g., “hours worked”) and estimated earnings for the user account (e.g., “earned so far”). Indeed, the digital deposit transaction prediction system 106 can utilize the geo-location data provided in the information indicator 726 to determine a predicted deposit transaction amount or an estimated deposit transaction amount earned so far (as described above) for the available deposit balance 724.

Additionally, as shown in FIG. 7C, the digital deposit transaction prediction system 106 provides, for display within the GUI 710 of the client device 708, trend information 728 for historical deposit transactions. In particular, as shown in FIG. 7C, the digital deposit transaction prediction system 106 provides, for display within the GUI 710, various information for historical deposit transactions. In particular, the trend information 728 includes highest deposit transaction values, average deposit transaction values, total earnings for a year, and average hours worked. In some cases, the trend information can also include various other data for the historical deposit transactions, such as, but not limited to, lowest deposit transaction values, median deposit transaction values, total earnings of all time, and/or highest hours worked.

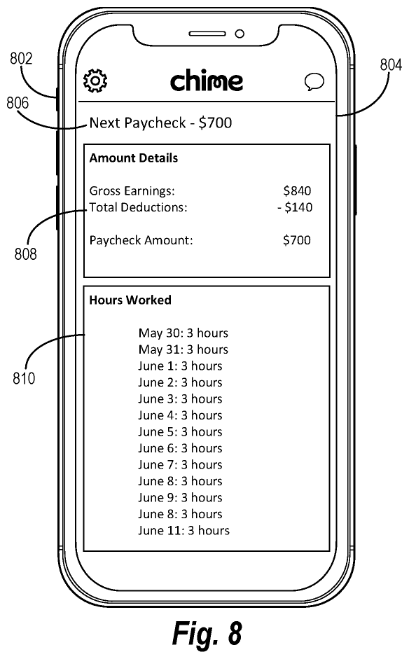

Additionally, in one or more embodiments, the digital deposit transaction prediction system 106 provides, for display within a graphical user interface, information for a predicted deposit transaction. For instance, FIG. 8 illustrates the digital deposit transaction prediction system 106 displaying various information from a predicted deposit transaction. For instance, as shown in FIG. 8, the digital deposit transaction prediction system 106 provides, for display within a GUI 804 of a client device 802, a predicted deposit transaction amount 806 (determined in accordance with one or more implementations herein). Moreover, as shown in FIG. 8, the digital deposit transaction prediction system 106 provides, for display within the GUI 804, an information indicator 808 for the predicted deposit transaction to present various details for the predicted deposit transaction. For instance, as shown in the information indicator 808, the digital deposit transaction prediction system 106 can present a total predicted deposit transaction (e.g., “gross earnings”) and a predicted deducted amount (e.g., from past utilization of an available deposit balance or other predicted deductions). Indeed, the digital deposit transaction prediction system 106 can utilize the total predicted deposit transaction and the predicted deducted amount to present a receivable predicted deposit transaction amount within the information indicator 808.

Furthermore, the digital deposit transaction prediction system 106 can determine and generate (e.g., from the deposit transaction predictor data pipeline) various other information in association with predicted deposit transactions. For instance, the digital deposit transaction prediction system 106 can determine a number of (estimated) hours worked by a user of a user account. For instance, as shown in FIG. 8, the digital deposit transaction prediction system 106 provides, for display within the GUI 804, an information indicator 810 to present (estimated) hours worked by a user of a user account.

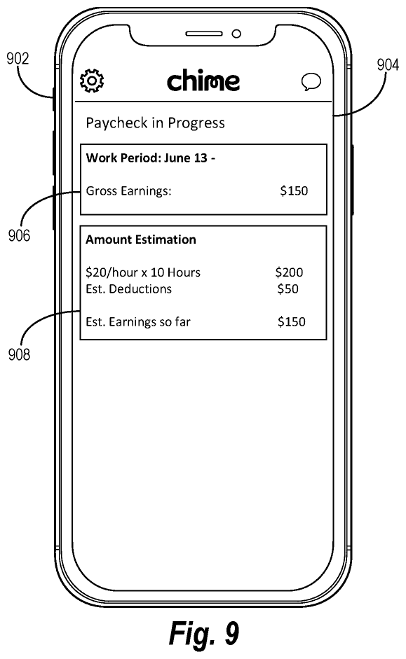

In addition, in some embodiments, the digital deposit transaction prediction system 106 provides additional information (or data) for current predicted earnings (e.g., an earning so far estimate). For example, FIG. 9 illustrates the digital deposit transaction prediction system 106 providing, for display within a graphical user interface, current predicted earnings (based on data from the deposit transaction predictor data pipeline). For example, as shown in FIG. 9, the digital deposit transaction prediction system 106 provides, for display within a GUI 904 of a client device 902, an information indicator 906 to present a current predicted deposit transaction earning (e.g., “gross earnings”). Moreover, as shown in FIG. 9, the digital deposit transaction prediction system 106 provides, for display within the GUI 904, an information indicator 908 that presents details on the information utilized by the deposit transaction predictor data pipeline to determine the current predicted deposit transaction earnings (e.g., an indicator to represent earned predicted deposit transaction amount). Indeed, as shown in FIG. 9, the information indicator 908 can include (or present) a predicted deposit transaction rate, a predicted number of hours worked to determine a current predicted deposit transaction earning. Furthermore, as shown in FIG. 9, the information indicator 908 can also include a predicted deducted amount (e.g., from past utilization of an available deposit balance or other predicted deductions) that results in the receivable predicted deposit transaction earnings amount.

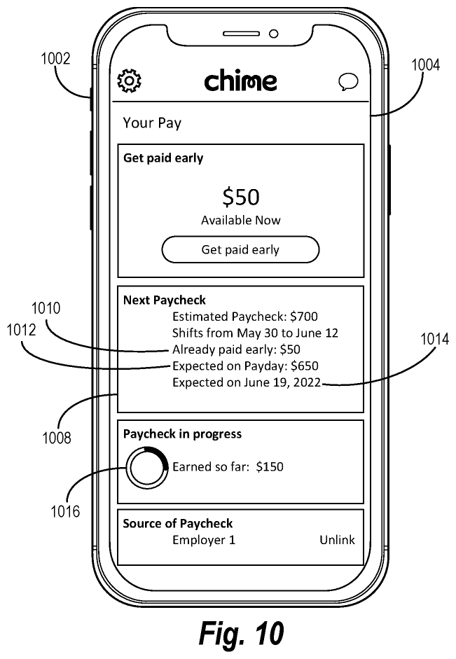

Furthermore, in one or more embodiments, the digital deposit transaction prediction system 106 determines an expected (or predicted) deposit transaction amount that accounts for previously utilized available deposit balances. For example, FIG. 10 illustrates the digital deposit transaction prediction system 106 displaying a predicted deposit transaction that accounts for previously utilized available deposit balances. For instance, as shown in FIG. 10, the digital deposit transaction prediction system 106 provides, for display within a GUI 1004 of a client device 1002, an information indicator 1008 that presents information for a predicted deposit transaction and information for deductions to the predicted deposit transaction. For example, as shown in FIG. 10, the digital deposit transaction prediction system 106 displays, within the information indicator 1008, an indicator 1010 that presents that the user account has already utilized an available deposit balance (e.g., already paid early: $50). Accordingly, as shown in FIG. 10, the digital deposit transaction prediction system 106 also displays, within the information indicator 1008, an indicator 1012 to illustrate that the estimated receivable predicted deposit transaction earnings amount will be different from the predicted deposit transaction amount (e.g., estimated paycheck of $700 but an expected amount of $650 based on the already paid early $50).

Additionally, as shown in FIG. 10, the digital deposit transaction prediction system 106 also provides, for display within the GUI 1004, an indicator 1014 to provide information for a predicted deposit transaction date. In particular, the digital deposit transaction prediction system 106 can utilize a predicted deposit transaction date received from the deposit transaction predictor data pipeline. Then, as shown in FIG. 10, the digital deposit transaction prediction system 106 can display the predicted deposit transaction date (e.g., within the indicator 1014).

As further shown in FIG. 10, the digital deposit transaction prediction system 106 also provides, for display within the GUI 1004, an indicator 1016 (e.g., a progress indicator) that represents an earned predicted deposit transaction amount for the user account. For example, as shown in FIG. 10, the indicator 1016 can represent the progress of an earned predicted deposit transaction amount in comparison to the predicted deposit transaction (from the information indicator 1008). As shown in FIG. 10, the indicator 1016 represents that the user account has an earned predicted deposit transaction amount of $150 and displays a progress tracker that displays, in terms of a percentage, that the earned predicted deposit transaction amount is approximately 25% of the predicted deposit transaction (e.g., $700).

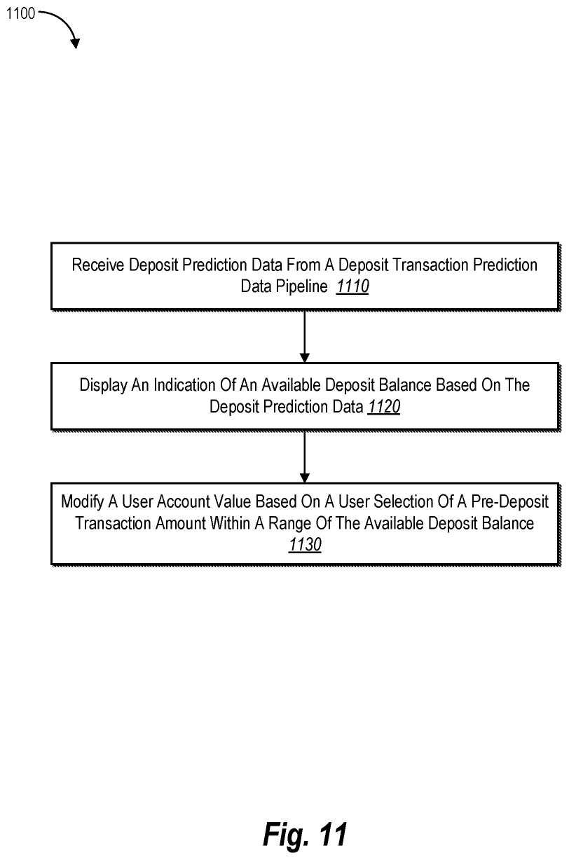

Turning now to FIG. 11, this figure shows a flowchart of a series of acts 1100 for utilizing deposit transaction prediction data from a deposit transaction predictor model to generate a graphical user interface (GUI) that indicates an available deposit balance and options for the available deposit balance in accordance with one or more implementations. While FIG. 11 illustrates acts according to one embodiment, alternative embodiments may omit, add to, reorder, and/or modify any of the acts shown in FIG. 11. The acts of FIG. 11 can be performed as part of a method. Alternatively, a non-transitory computer readable storage medium can comprise instructions that, when executed by the one or more processors, cause a computing device to perform the acts depicted in FIG. 11. In still further embodiments, a system can perform the acts of FIG. 11.

As shown in FIG. 11, the series of acts 1100 include an act 1110 of receiving deposit prediction data from a deposit transaction prediction data pipeline. For instance, the act 1110 can include based on a data request to a data pipeline comprising a deposit transaction predictor model, receiving value-based deposit prediction data for a user account. Furthermore, the act 1110 can include receiving time-based deposit prediction data for a user account based on a data request to a data pipeline comprising a deposit transaction predictor model. Moreover, the act 1110 can include receiving value-based deposit prediction data (and/or time-based deposit prediction data) for a user account by retrieving output data of a deposit transaction predictor model analyzing user account data. For example, user account data can include historical deposit transaction data corresponding to the user account, geo-location data from a client device corresponding to the user account, or deposit transaction source information corresponding to the user account. Furthermore, value-based deposit prediction data can include one or more predicted deposit transaction monetary amounts determined from one or more predicted deposit transactions.

As also shown in FIG. 11, the series of acts 1100 include an act 1120 of displaying an indication of an available deposit balance based on the deposit prediction data. For example, the act 1120 can include providing, for display within a graphical user interface of a computing device corresponding to a user account, an indication of an available deposit balance from a value-based deposit prediction data. Additionally, the act 1120 can include providing, for display within a graphical user interface of a computing device corresponding to a user account, an indication of the predicted deposit transaction date from time-based deposit prediction data.

Moreover, the act 1120 can include determining an available deposit balance for a user account utilizing a predicted deposit transaction rate based on one or more predicted deposit transaction monetary amounts and one or more predicted dates for one or more predicted deposit transactions determined from time-based deposit prediction data. In addition, the act 1120 can include determining an available deposit balance from value-based deposit prediction data based on a predicted deposit transaction rate and a geo-location of the computing device corresponding to a user account. Additionally, the act 1120 can include providing, for display within a graphical user interface, an indicator representing an earned predicted deposit transaction amount for a user account based on value-based deposit prediction data, a predicted deposit transaction rate, a date of a previous deposit transaction, and a current date.

In some cases, the act 1120 can include determining an available deposit balance by selecting the available deposit balance utilizing one or more user activities of a user account with an available deposit balance model comprising mappings between deposit prediction amounts and one or more available deposit balance values. For example, the act 1120 can include determining a user account activity tier for a user account using one or more user activities. Moreover, the act 1120 can include determining an available deposit balance utilizing value-based deposit prediction data and a user account activity tier by selecting a particular available deposit balance from one or more available deposit balance values in an available deposit balance model based on mappings to both one or more deposit prediction amounts and one or more user account activity tiers.

As shown in FIG. 11, the series of acts 1100 include an act 1130 of modifying a user account value based on a user selection of a pre-deposit transaction amount within a range of the available deposit balance. In particular, the act 1130 can include, based on detecting a user selection of a pre-deposit transaction amount within a range of an available deposit balance, modifying a user account value corresponding to a user account utilizing the selected pre-deposit transaction amount. In some cases, the act 1130 can include, upon detecting a subsequent deposit transaction for a user account, reducing an amount corresponding to the subsequent deposit transaction by a pre-deposit transaction amount.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory), and executes those instructions, thereby performing one or more processes, including one or more of the processes described herein.

Computer-readable media can be any available media that can be accessed by a general purpose or special purpose computer system, including by one or more servers. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, virtual reality devices, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 12 illustrates, in block diagram form, an exemplary computing device 1200 that may be configured to perform one or more of the processes described above. One will appreciate that the digital deposit transaction prediction system 106 (or the inter-network facilitation system 104) can comprise implementations of a computing device, including, but not limited to, the devices or systems illustrated in the previous figures. As shown by FIG. 12, the computing device can comprise a processor 1202, memory 1204, a storage device 1206, an I/O interface 1208, and a communication interface 1210. In certain embodiments, the computing device 1200 can include fewer or more components than those shown in FIG. 12. Components of computing device 1200 shown in FIG. 12 will now be described in additional detail.

In particular embodiments, processor(s) 1202 includes hardware for executing instructions, such as those making up a computer program. As an example, and not by way of limitation, to execute instructions, processor(s) 1202 may retrieve (or fetch) the instructions from an internal register, an internal cache, memory 1204, or a storage device 1206 and decode and execute them.

The computing device 1200 includes memory 1204, which is coupled to the processor(s) 1202. The memory 1204 may be used for storing data, metadata, and programs for execution by the processor(s). The memory 1204 may include one or more of volatile and non-volatile memories, such as Random Access Memory (“RAM”), Read Only Memory (“ROM”), a solid-state disk (“SSD”), Flash, Phase Change Memory (“PCM”), or other types of data storage. The memory 1204 may be internal or distributed memory.

The computing device 1200 includes a storage device 1206 includes storage for storing data or instructions. As an example, and not by way of limitation, storage device 1206 can comprise a non-transitory storage medium described above. The storage device 1206 may include a hard disk drive (“HDD”), flash memory, a Universal Serial Bus (“USB”) drive or a combination of these or other storage devices.

The computing device 1200 also includes one or more input or output (“I/O”) interface 1208, which are provided to allow a user (e.g., requester or provider) to provide input to (such as user strokes), receive output from, and otherwise transfer data to and from the computing device 1200. These I/O interface 1208 may include a mouse, keypad or a keyboard, a touch screen, camera, optical scanner, network interface, modem, other known I/O devices or a combination of such I/O interface 1208. The touch screen may be activated with a stylus or a finger.

The I/O interface 1208 may include one or more devices for presenting output to a user, including, but not limited to, a graphics engine, a display (e.g., a display screen), one or more output providers (e.g., display providers), one or more audio speakers, and one or more audio providers. In certain embodiments, the I/O interface 1208 is configured to provide graphical data to a display for presentation to a user. The graphical data may be representative of one or more graphical user interfaces and/or any other graphical content as may serve a particular implementation.

The computing device 1200 can further include a communication interface 1210. The communication interface 1210 can include hardware, software, or both. The communication interface 1210 can provide one or more interfaces for communication (such as, for example, packet-based communication) between the computing device and one or more other computing devices 1200 or one or more networks. As an example, and not by way of limitation, communication interface 1210 may include a network interface controller (“NIC”) or network adapter for communicating with an Ethernet or other wire-based network or a wireless NIC (“WNIC”) or wireless adapter for communicating with a wireless network, such as a WI-FI. The computing device 1200 can further include a bus 1212. The bus 1212 can comprise hardware, software, or both that couples components of computing device 1200 to each other.

FIG. 13 illustrates an example network environment 1300 of the inter-network facilitation system 104. The network environment 1300 includes a client device 1306 (e.g., client device 110), an inter-network facilitation system 104, and a third-party system 1308 connected to each other by a network 1304. Although FIG. 13 illustrates a particular arrangement of the client device 1306, the inter-network facilitation system 104, the third-party system 1308, and the network 1304, this disclosure contemplates any suitable arrangement of client device 1306, the inter-network facilitation system 104, the third-party system 1308, and the network 1304. As an example, and not by way of limitation, two or more of client device 1306, the inter-network facilitation system 104, and the third-party system 1308 communicate directly, bypassing network 1304. As another example, two or more of client device 1306, the inter-network facilitation system 104, and the third-party system 1308 may be physically or logically co-located with each other in whole or in part.

Moreover, although FIG. 13 illustrates a particular number of client devices 1306, inter-network facilitation system 104, third-party systems 1308, and networks 1304, this disclosure contemplates any suitable number of client devices 1306, FIG. 13, third-party systems 1308, and networks 1304. As an example, and not by way of limitation, network environment 1300 may include multiple client devices 1306, inter-network facilitation system 104, third-party systems 1308, and/or networks 1304.

This disclosure contemplates any suitable network 1304. As an example, and not by way of limitation, one or more portions of network 1304 may include an ad hoc network, an intranet, an extranet, a virtual private network (“VPN”), a local area network (“LAN”), a wireless LAN (“WLAN”), a wide area network (“WAN”), a wireless WAN (“WWAN”), a metropolitan area network (“MAN”), a portion of the Internet, a portion of the Public Switched Telephone Network (“PSTN”), a cellular telephone network, or a combination of two or more of these. Network 1304 may include one or more networks 1304.

Links may connect client device 1306, inter-network facilitation system 104 (e.g., which hosts the digital deposit transaction prediction system 106), and third-party system 1308 to network 1304 or to each other. This disclosure contemplates any suitable links. In particular embodiments, one or more links include one or more wireline (such as for example Digital Subscriber Line (“DSL”) or Data Over Cable Service Interface Specification (“DOCSIS”), wireless (such as for example Wi-Fi or Worldwide Interoperability for Microwave Access (“WiMAX”), or optical (such as for example Synchronous Optical Network (“SONET”) or Synchronous Digital Hierarchy (“SDH”) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout network environment 1300. One or more first links may differ in one or more respects from one or more second links.

In particular embodiments, the client device 1306 may be an electronic device including hardware, software, or embedded logic components or a combination of two or more such components and capable of carrying out the appropriate functionalities implemented or supported by client device 1306. As an example, and not by way of limitation, a client device 1306 may include any of the computing devices discussed above in relation to FIG. 12. A client device 1306 may enable a network user at the client device 1306 to access network 1304. A client device 1306 may enable its user to communicate with other users at other client devices 1306.

In particular embodiments, the client device 1306 may include a requester application or a web browser, such as MICROSOFT INTERNET EXPLORER, GOOGLE CHROME, or MOZILLA FIREFOX, and may have one or more add-ons, plug-ins, or other extensions, such as TOOLBAR or YAHOO TOOLBAR. A user at the client device 1306 may enter a Uniform Resource Locator (“URL”) or other address directing the web browser to a particular server (such as server), and the web browser may generate a Hyper Text Transfer Protocol (“HTTP”) request and communicate the HTTP request to server. The server may accept the HTTP request and communicate to the client device 1306 one or more Hyper Text Markup Language (“HTML”) files responsive to the HTTP request. The client device 1306 may render a webpage based on the HTML files from the server for presentation to the user. This disclosure contemplates any suitable webpage files. As an example, and not by way of limitation, webpages may render from HTML files, Extensible Hyper Text Markup Language (“XHTML”) files, or Extensible Markup Language (“XML”) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, inter-network facilitation system 104 may be a network-addressable computing system that can interface between two or more computing networks or servers associated with different entities such as financial institutions (e.g., banks, credit processing systems, ATM systems, or others). In particular, the inter-network facilitation system 104 can send and receive network communications (e.g., via the network 1304) to link the third-party-system 1308. For example, the inter-network facilitation system 104 may receive authentication credentials from a user to link a third-party system 1308 such as an online bank account, credit account, debit account, or other financial account to a user account within the inter-network facilitation system 104. The inter-network facilitation system 104 can subsequently communicate with the third-party system 1308 to detect or identify balances, transactions, withdrawal, transfers, deposits, credits, debits, or other transaction types associated with the third-party system 1308. The inter-network facilitation system 104 can further provide the aforementioned or other financial information associated with the third-party system 1308 for display via the client device 1306. In some cases, the inter-network facilitation system 104 links more than one third-party system 1308, receiving account information for accounts associated with each respective third-party system 1308 and performing operations or transactions between the different systems via authorized network connections.

In particular embodiments, the inter-network facilitation system 104 may interface between an online banking system and a credit processing system via the network 1304. For example, the inter-network facilitation system 104 can provide access to a bank account of a third-party system 1308 and linked to a user account within the inter-network facilitation system 104. Indeed, the inter-network facilitation system 104 can facilitate access to, and transactions to and from, the bank account of the third-party system 1308 via a client application of the inter-network facilitation system 104 on the client device 1306. The inter-network facilitation system 104 can also communicate with a credit processing system, an ATM system, and/or other financial systems (e.g., via the network 1304) to authorize and process credit charges to a credit account, perform ATM transactions, perform transfers (or other transactions) across accounts of different third-party systems 1308, and to present corresponding information via the client device 1306.

In particular embodiments, the inter-network facilitation system 104 includes a model for approving or denying transactions. For example, the inter-network facilitation system 104 includes a transaction approval machine learning model that is trained based on training data such as user account information (e.g., name, age, location, and/or income), account information (e.g., current balance, average balance, maximum balance, and/or minimum balance), credit usage, and/or other transaction history. Based on one or more of these data (from the inter-network facilitation system 104 and/or one or more third-party systems 1308), the inter-network facilitation system 104 can utilize the transaction approval machine learning model to generate a prediction (e.g., a percentage likelihood) of approval or denial of a transaction (e.g., a withdrawal, a transfer, or a purchase) across one or more networked systems.

The inter-network facilitation system 104 may be accessed by the other components of network environment 1300 either directly or via network 1304. In particular embodiments, the inter-network facilitation system 104 may include one or more servers. Each server may be a unitary server or a distributed server spanning multiple computers or multiple datacenters. Servers may be of various types, such as, for example and without limitation, web server, news server, mail server, message server, advertising server, file server, application server, exchange server, database server, proxy server, another server suitable for performing functions or processes described herein, or any combination thereof. In particular embodiments, each server may include hardware, software, or embedded logic components or a combination of two or more such components for carrying out the appropriate functionalities implemented or supported by the server. In particular embodiments, the inter-network facilitation system 104 may include one or more data stores. Data stores may be used to store various types of information. In particular embodiments, the information stored in data stores may be organized according to specific data structures. In particular embodiments, each data store may be a relational, columnar, correlation, or other suitable database. Although this disclosure describes or illustrates particular types of databases, this disclosure contemplates any suitable types of databases. Particular embodiments may provide interfaces that enable a client device 1306, or an inter-network facilitation system 104 to manage, retrieve, modify, add, or delete, the information stored in a data store.

In particular embodiments, the inter-network facilitation system 104 may provide users with the ability to take actions on various types of items or objects, supported by the inter-network facilitation system 104. As an example, and not by way of limitation, the items and objects may include financial institution networks for banking, credit processing, or other transactions, to which users of the inter-network facilitation system 104 may belong, computer-based applications that a user may use, transactions, interactions that a user may perform, or other suitable items or objects. A user may interact with anything that is capable of being represented in the inter-network facilitation system 104 or by an external system of a third-party system, which is separate from inter-network facilitation system 104 and coupled to the inter-network facilitation system 104 via a network 1304.

In particular embodiments, the inter-network facilitation system 104 may be capable of linking a variety of entities. As an example, and not by way of limitation, the inter-network facilitation system 104 may enable users to interact with each other or other entities, or to allow users to interact with these entities through an application programming interfaces (“API”) or other communication channels.

In particular embodiments, the inter-network facilitation system 104 may include a variety of servers, sub-systems, programs, modules, logs, and data stores. In particular embodiments, the inter-network facilitation system 104 may include one or more of the following: a web server, action logger, API-request server, transaction engine, cross-institution network interface manager, notification controller, action log, third-party-content-object-exposure log, inference module, authorization/privacy server, search module, user-interface module, user-profile (e.g., provider profile or requester profile) store, connection store, third-party content store, or location store. The inter-network facilitation system 104 may also include suitable components such as network interfaces, security mechanisms, load balancers, failover servers, management-and-network-operations consoles, other suitable components, or any suitable combination thereof. In particular embodiments, the inter-network facilitation system 104 may include one or more user-profile stores for storing user profiles for transportation providers and/or transportation requesters. A user profile may include, for example, biographic information, demographic information, financial information, behavioral information, social information, or other types of descriptive information, such as interests, affinities, or location.

The web server may include a mail server or other messaging functionality for receiving and routing messages between the inter-network facilitation system 104 and one or more client devices 1306. An action logger may be used to receive communications from a web server about a user's actions on or off the inter-network facilitation system 104. In conjunction with the action log, a third-party-content-object log may be maintained of user exposures to third-party-content objects. A notification controller may provide information regarding content objects to a client device 1306. Information may be pushed to a client device 1306 as notifications, or information may be pulled from client device 1306 responsive to a request received from client device 1306. Authorization servers may be used to enforce one or more privacy settings of the users of the inter-network facilitation system 104. A privacy setting of a user determines how particular information associated with a user can be shared. The authorization server may allow users to opt in to or opt out of having their actions logged by the inter-network facilitation system 104 or shared with other systems, such as, for example, by setting appropriate privacy settings. Third-party-content-object stores may be used to store content objects received from third parties. Location stores may be used for storing location information received from client devices 1306 associated with users.

In addition, the third-party system 1308 can include one or more computing devices, servers, or sub-networks associated with internet banks, central banks, commercial banks, retail banks, credit processors, credit issuers, ATM systems, credit unions, loan associates, brokerage firms, linked to the inter-network facilitation system 104 via the network 1304. A third-party system 1308 can communicate with the inter-network facilitation system 104 to provide financial information pertaining to balances, transactions, and other information, whereupon the inter-network facilitation system 104 can provide corresponding information for display via the client device 1306. In particular embodiments, a third-party system 1308 communicates with the inter-network facilitation system 104 to update account balances, transaction histories, credit usage, and other internal information of the inter-network facilitation system 104 and/or the third-party system 1308 based on user interaction with the inter-network facilitation system 104 (e.g., via the client device 1306). Indeed, the inter-network facilitation system 104 can synchronize information across one or more third-party systems 1308 to reflect accurate account information (e.g., balances, transactions, etc.) across one or more networked systems, including instances where a transaction (e.g., a transfer) from one third-party system 1308 affects another third-party system 1308.

In the foregoing specification, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

1. A computer-implemented method comprising:
receiving, from a client device with a global positioning system (GPS) sensor, geo-location data of the client device, wherein the client device corresponds to a user account;
analyzing the geo-location data of the client device to determine a time duration of the client device at a geo-location from the geo-location data;
utilizing a deposit transaction predictor model, from a data pipeline that determines future deposit transaction activity for the user account, with user account data from one or more data sources to determine value-based deposit prediction data indicating the future deposit transaction activity for the user account from an analysis of the user account data by the deposit transaction predictor model, wherein the user account data comprises historical deposit transaction data corresponding to the user account, the geo-location data received from the client device corresponding to the user account, and the time duration of the client device at the geo-location;
determining, utilizing an available deposit balance model, an available deposit balance for the user account by utilizing the value-based deposit prediction data, from the deposit transaction predictor model, as input into the available deposit balance model;
providing, for display within a graphical user interface of the client device corresponding to the user account, an indication of the available deposit balance determined from the available deposit balance model; and
based on detecting, within the graphical user interface, a user selection of a pre-deposit transaction amount within a range of the available deposit balance, modifying a user account value corresponding to the user account utilizing the selected pre-deposit transaction amount.

2. The computer-implemented method of claim 1, further comprising:
determining time-based deposit prediction data for the user account utilizing the deposit transaction predictor model; and
providing, for display within the graphical user interface of the client device corresponding to the user account, an indication of a predicted deposit transaction date from the time-based deposit prediction data.

3. The computer-implemented method of claim 1, further comprising determining the value-based deposit prediction data for the user account by retrieving output data of the deposit transaction predictor model analyzing the historical deposit transaction data corresponding to the user account, the geo-location data from a client device corresponding to the user account, and the time duration of the client device at the geo-location.

4. The computer-implemented method of claim 1, wherein the value-based deposit prediction data comprises one or more predicted deposit transaction monetary amounts determined from one or more predicted deposit transactions.

5. The computer-implemented method of claim 4, further comprising determining the available deposit balance for the user account utilizing a predicted deposit transaction rate based on the one or more predicted deposit transaction monetary amounts and one or more predicted dates for the one or more predicted deposit transactions determined from time-based deposit prediction data.

6. The computer-implemented method of claim 5, further comprising determining the available deposit balance from the value-based deposit prediction data based on the predicted deposit transaction rate, the geo-location data of the client device corresponding to the user account, and the time duration of the client device at the geo-location.

7. The computer-implemented method of claim 5, further comprising providing, for display within the graphical user interface, an indicator representing an earned predicted deposit transaction amount for the user account based on the value-based deposit prediction data, the predicted deposit transaction rate, a date of a previous deposit transaction, and a current date.

8. The computer-implemented method of claim 1, further comprising determining the available deposit balance by selecting the available deposit balance utilizing one or more user activities of the user account with the available deposit balance model comprising mappings between deposit prediction amounts and one or more available deposit balance values.

9. The computer-implemented method of claim 1, further comprising, upon detecting a subsequent deposit transaction for the user account, reducing an amount corresponding to the subsequent deposit transaction by the pre-deposit transaction amount.

10. A non-transitory computer-readable medium storing instructions that, when executed by at least one processor, cause a computing device to:
receive, from a client device with a global positioning system (GPS) sensor, geo-location data of the client device, wherein the client device corresponds to a user account;
analyze the geo-location data of the client device to determine a time duration of the client device at a geo-location from the geo-location data;
utilize a deposit transaction predictor model, from a data pipeline that determines future deposit transaction activity for the user account, with user account data from one or more data sources to determine value-based deposit prediction data indicating the future deposit transaction activity for the user account from an analysis of the user account data by the deposit transaction predictor model, wherein the user account data comprises historical deposit transaction data corresponding to the user account, the geo-location data received from the client device corresponding to the user account, and the time duration of the client device at the geo-location;
determining, utilizing an available deposit balance model, an available deposit balance for the user account by utilizing the value-based deposit prediction data, from the deposit transaction predictor model, as input into the available deposit balance model;
provide, for display within a graphical user interface of the client device corresponding to the user account, an indication of the available deposit balance determined from the available deposit balance model; and
based on detecting, within the graphical user interface, a user selection of a pre-deposit transaction amount within a range of the available deposit balance, modify a user account value corresponding to the user account utilizing the selected pre-deposit transaction amount.

11. The non-transitory computer-readable medium of claim 10,
further comprising instructions that, when executed by the at least one processor, cause the computing device to determine the value-based deposit prediction data for the user account by retrieving output data of the deposit transaction predictor model analyzing the historical deposit transaction data corresponding to the user account, the geo-location data from the client device corresponding to the user account, and the time duration of the client device at the geo-location.

12. The non-transitory computer-readable medium of claim 10, wherein the value-based deposit prediction data comprises one or more predicted deposit transaction monetary amounts determined from one or more predicted deposit transactions and further comprising instructions that, when executed by the at least one processor, cause the computing device to determine the available deposit balance for the user account utilizing a predicted deposit transaction rate based on the one or more predicted deposit transaction monetary amounts and one or more predicted dates for the one or more predicted deposit transactions determined from time-based deposit prediction data.

13. The non-transitory computer-readable medium of claim 12, further comprising instructions that, when executed by the at least one processor, cause the computing device to determine the available deposit balance from the value-based deposit prediction data based on the predicted deposit transaction rate, the geo-location data of the client device corresponding to the user account, and the time duration of the client device at the geo-location.

14. The non-transitory computer-readable medium of claim 10, further comprising instructions that, when executed by the at least one processor, cause the computing device to provide, for display within the graphical user interface of the client device, an indicator representing an earned predicted deposit transaction amount for the user account based on the value-based deposit prediction data, a predicted deposit date, a date of a previous deposit transaction, and a current date.

15. The non-transitory computer-readable medium of claim 10, further comprising instructions that, when executed by the at least one processor, cause the computing device to determine the available deposit balance by selecting the available deposit balance utilizing one or more user activities of the user account with the available deposit balance model comprising mappings between deposit prediction amounts and one or more available deposit balance values.

16. A system comprising:
at least one processor; and
at least one non-transitory computer-readable storage medium storing instructions that, when executed by the at least one processor, cause the system to:
receive, from a client device with a global positioning system (GPS) sensor, geo-location data of the client device, wherein the client device corresponds to a user account;
analyze the geo-location data of the client device to determine a time duration of the client device at a geo-location from the geo-location data;
utilize a deposit transaction predictor model, from a data pipeline that determines future deposit transaction activity for the user account, with user account data from one or more data sources to determine value-based deposit prediction data indicating the future deposit transaction activity for the user account from an analysis of the user account data by the deposit transaction predictor model, wherein the user account data comprises historical deposit transaction data corresponding to the user account, the geo-location data received from the client device corresponding to the user account, and the time duration of the client device at the geo-location;
determining, utilizing an available deposit balance model, an available deposit balance for the user account by utilizing the value-based deposit prediction data, from the deposit transaction predictor model, as input into the available deposit balance model;
provide, for display within a graphical user interface of the client device corresponding to the user account, an indication of the available deposit balance determined from the available deposit balance model; and
based on detecting, within the graphical user interface, a user selection of a pre-deposit transaction amount within a range of the available deposit balance, modify a user account value corresponding to the user account utilizing the selected pre-deposit transaction amount.

17. The system of claim 16, further comprising instructions that, when executed by the at least one processor, cause the system to:
determine time-based deposit prediction data for the user account utilizing the deposit transaction predictor model;
determine a predicted deposit transaction rate for the user account utilizing the time-based deposit prediction data; and
determine the available deposit balance from the value-based deposit prediction data based on the predicted deposit transaction rate, the geo-location data of the client device corresponding to the user account, and the time duration of the client device at the geo-location.

18. The system of claim 16, wherein the value-based deposit prediction data comprises one or more predicted deposit transaction monetary amounts determined from one or more predicted deposit transactions and further comprising instructions that, when executed by the at least one processor, cause the system to determine the available deposit balance for the user account utilizing a predicted deposit transaction rate based on the one or more predicted deposit transaction monetary amounts and one or more predicted dates for the one or more predicted deposit transactions determined from time-based deposit prediction data.

19. The system of claim 16, further comprising instructions that, when executed by the at least one processor, cause the system to determine the available deposit balance by selecting the available deposit balance utilizing one or more user activities of the user account with the available deposit balance model comprising mappings between one or more deposit prediction amounts and one or more available deposit balance values.

20. The system of claim 19, further comprising instructions that, when executed by the at least one processor, cause the system to:
determine a user account activity tier for the user account using the one or more user activities; and
determine the available deposit balance utilizing the value-based deposit prediction data and the user account activity tier by selecting a particular available deposit balance from the one or more available deposit balance values in the available deposit balance model based on mappings to both the one or more deposit prediction amounts and one or more user account activity tiers.
